(19) United States
(12) Patent Application Publication
(10) Pub. No.: US 2026/0135586 A1
(43) Pub. Date: May 14, 2026

(54) RADIO FREQUENCY CIRCUIT AND COMMUNICATION APPARATUS

(71) Applicant: Murata Manufacturing Co., Ltd., Nagaokakyo-shi (JP)

(72) Inventors: Masayuki MAEZAWA, Nagaokakyo-shi (JP); Morio TAKEUCHI, Nagaokakyo-shi (JP)

(73) Assignee: Murata Manufacturing Co., Ltd., Nagaokakyo-shi (JP)

(21) Appl. No.: 19/438,656

(22) Filed: Jan. 2, 2026

Related U.S. Application Data
(63) Continuation of application No. PCT/JP2024/022203, filed on Jun. 19, 2024.

(30) Foreign Application Priority Data
Jul. 20, 2023 (JP) 2023-118484

(51) Int. Cl. H04B 1/401; H04B 1/3805; H04B 1/44

(52) U.S. Cl. CPC H04B 1/401; H04B 1/3805; H04B 1/44

(57) ABSTRACT

A radio frequency circuit includes a first switch circuit, a second switch, and a transceiver circuit portion connected. The first switch includes first and second common terminals connected to first and second antenna connection terminals and first and second selection terminals. The second switch circuit includes a third common terminal connected to the first selection terminal and a third selection terminal connected to a first reception filter having a pass band including a first band. The transceiver circuit portion is connected to the second selection terminal of the first switch circuit, and includes a transmission path for the first band and a second reception path for the first band.

### CROSS-REFERENCE TO RELATED APPLICATIONS

This application is a bypass continuation application of International Patent Application No. PCT/JP2024/022203, filed on Jun. 19, 2024, which claims the benefit of priority to Japanese Patent Application No. 2023-118484, filed on Jul. 20, 2023, the entire contents of each are incorporated herein by reference.

### TECHNICAL FIELD

The present disclosure relates to a radio frequency circuit and a communication apparatus.

### BACKGROUND ART

In mobile communication apparatuses such as mobile phones, to improve the data rate of a wireless link, implementation of carrier aggregation (CA), dual connectivity (DC), and the like in which multiple channels in multiple frequency bands or in the same frequency band are used simultaneously is being progressed. Furthermore, implementation of multiple-input and multiple-output (MIMO) that enables multipath transmission using a plurality of antennas is also being progressed.

In Patent Document 1, a radio frequency module (radio frequency circuit) and a communication apparatus that support simultaneous reception of a plurality of reception signals and transmission of a transmission signal in bands for TDD are disclosed.

### CITATION LIST

### Patent Document

Patent Document 1: Japanese Unexamined Patent Application Publication (Translation of PCT Application) No. 2022-19182

### SUMMARY

A radio frequency circuit according to an aspect of the present disclosure includes a first switch circuit, a second switch, and a transceiver circuit portion connected. The first switch includes first and second common terminals connected to first and second antenna connection terminals and first and second selection terminals. The second switch circuit includes a third common terminal connected to the first selection terminal and a third selection terminal connected to a first reception filter having a pass band including a first band. The transceiver circuit portion is connected to the second selection terminal of the first switch circuit, and includes a transmission path for the first band and a second reception path for the first band. The radio frequency circuit is configured to simultaneously receive signals in the first band via the first reception filter and the second reception path.

A radio frequency circuit according to an aspect of the present disclosure includes a first switch circuit including a first common terminal connected to a first antenna connection terminal, a second common terminal connected to a second antenna connection terminal, a first selection terminal, and a second selection terminal; a second switch circuit including a third common terminal connected to the first selection terminal, a third selection terminal, and a fourth selection terminal; a third switch circuit including a fourth common terminal, a fifth selection terminal connected to a second low noise amplifier, and a sixth selection terminal connected to a power amplifier; a first filter connected between the third selection terminal and a first low noise amplifier and having a pass band including a first band for TDD; a second filter connected between the second selection terminal and the fourth common terminal and having a pass band including the first band; and a third filter connected between the fourth selection terminal and a third low noise amplifier and having a pass band including at least part of a second band.

A radio frequency circuit includes a first switch circuit including a first common terminal connected to a first antenna connection terminal, a second common terminal connected to a second antenna connection terminal, a first selection terminal, a second selection terminal, and a third selection terminal; a second switch circuit including a third common terminal connected to the first selection terminal, a fourth selection terminal, and a fifth selection terminal; a first filter connected between the fourth selection terminal and a first low noise amplifier and having a pass band including a first band for TDD; a second filter connected between the second selection terminal and a second low noise amplifier and having a pass band including the first band; a third filter connected between the third selection terminal and a power amplifier and having a pass band including the first band; and a fourth filter connected between the fifth selection terminal and a third low noise amplifier and having a pass band including at least part of a second band.

### BRIEF DESCRIPTION OF DRAWINGS

FIG. 1 is a circuit configuration diagram of a radio frequency circuit and a communication apparatus according to a first embodiment.

FIG. 2 is a circuit configuration diagram of a first switch circuit in the first embodiment.

FIG. 3 is a circuit configuration diagram of a second switch circuit in the first embodiment.

FIG. 4 is a circuit configuration diagram of a third switch circuit in the first embodiment.

FIG. 5 is an explanatory diagram of a first communication mode of the communication apparatus according to the first embodiment.

FIG. 6 is an explanatory diagram of a second communication mode of the communication apparatus according to the first embodiment.

FIG. 7 is an explanatory diagram of a third communication mode of the communication apparatus according to the first embodiment.

FIG. 8 is an explanatory diagram of a fourth communication mode of the communication apparatus according to the first embodiment.

FIG. 9 is an explanatory diagram of a fifth communication mode of the communication apparatus according to the first embodiment.

FIG. 10 is a circuit configuration diagram of a radio frequency circuit and a communication apparatus according to a second embodiment.

FIG. 11 is a circuit configuration diagram of a first switch circuit in the second embodiment.

FIG. 12 is an explanatory diagram of a first communication mode of the communication apparatus according to the second embodiment.

FIG. 13 is an explanatory diagram of a second communication mode of the communication apparatus according to the second embodiment.

FIG. 14 is an explanatory diagram of a third communication mode of the communication apparatus according to the second embodiment.

FIG. 15 is an explanatory diagram of a fourth communication mode of the communication apparatus according to the second embodiment.

FIG. 16 is an explanatory diagram of a fifth communication mode of the communication apparatus according to the second embodiment.

### DESCRIPTION OF EMBODIMENTS

Hereinafter, embodiments of the present invention will be described in detail with reference to drawings. The embodiments described below each illustrate a comprehensive or specific example. Numerical values, shapes, materials, component elements, arrangements of the component elements, manners in which the component elements are connected, and so on illustrated in the embodiments described below are merely examples and are not intended to limit the present invention.

The drawings are schematic diagrams in which emphasis, omission, or ratio adjustment is performed in an appropriate manner in order that the present invention is illustrated. The drawings are not necessarily illustrated precisely and may differ from actual shapes, positional relationships, and ratios. In the drawings, substantially the same configurations are denoted by the same reference signs, and repetitive description may be omitted or simplified.

In the present disclosure, “being connected” not only represents being directly connected by a connection terminal and/or a wiring conductor but also includes being electrically connected with another circuit element interposed therebetween.

“A is connected between B and C” represents a state in which one end of A is connected to B and the other end of A is connected to C and represents a state in which A is connected in series to a path connecting B to C.

A “terminal” represents a point at which a conductor inside an element terminates. In the case where the impedance of a conductor between elements is sufficiently low, a terminal is not necessarily construed as a single point but may also be construed as a point in the conductor between the elements or the entire conductor.

A “pass band of a filter” is a part of a frequency spectrum that transmits through the filter and is defined as a frequency range in which output power is not attenuated from the maximum output power by 3 dB or more. Thus, a higher frequency end and a lower frequency end of a pass band of a band pass filter are identified as a higher frequency and a lower frequency of two points where output power is attenuated from the maximum output power by 3 dB.

A “band combination capable of simultaneous transmission/reception” represents a plurality of bands defined in advance as a combination of bands in which simultaneous transmission/reception of signals can be performed. A “band combination capable of simultaneous communication” is defined by standardization organizations or other bodies (for example, 3rd Generation Partnership Project (3GPP (registered trademark)), Institute of Electrical and Electronics Engineers (IEEE), or the like). The “band combination capable of simultaneous transmission/reception” is defined as, for example, a band combination for carrier aggregation (CA), E-UTRAN-New Radio dual connectivity (EN-DC), New Radio dual connectivity (NR-DC), or New Radio-E-UTRAN dual connectivity (NE-DC).

A “reception band” represents a frequency band used for reception in a communication apparatus, and a “transmission band” represents a frequency band used for transmission in the communication apparatus. For example, in the case of bands for frequency division duplex (FDD), different frequency bands (an uplink band and a downlink band) are used as a transmission band and a reception band. Furthermore, for example, in the case of bands for time division duplex (TDD), the same frequency band is used as a transmission band and a reception band.

The inventors have recognized that, in the known technology mentioned above, large signal loss occurs in a transmission path, and furthermore, miniaturization of the radio frequency circuit and the communication apparatus is difficult.

Accordingly, the present disclosure is directed to providing a radio frequency circuit and a communication apparatus capable of reducing signal loss in a transmission path and miniaturizing the radio frequency circuit and/or the communication apparatus. A radio frequency circuit and a communication apparatus according to the present disclosure can reduce signal loss in a transmission path and achieve miniaturization of the radio frequency circuit and/or the communication apparatus.

### First Embodiment

A first embodiment will be described. A communication apparatus 5 according to this embodiment can be used to provide wireless connection. For example, the communication apparatus 5 can be mounted in a user terminal (user equipment (UE)) in a cellular network (also called a mobile network), such as a mobile phone, a smartphone, a tablet computer, or a wearable device. In another example, devices in which the communication apparatus 5 is mounted, such as an Internet of Things (IoT) sensor device, a medical/healthcare device, a vehicle, an unmanned aerial vehicle (UAV) (a so-called drone), and an automated guided vehicle (AGV), can provide wireless connection. In still another example, by mounting of the communication apparatus 5, wireless connection can be provided at a wireless access point or a wireless hotspot.

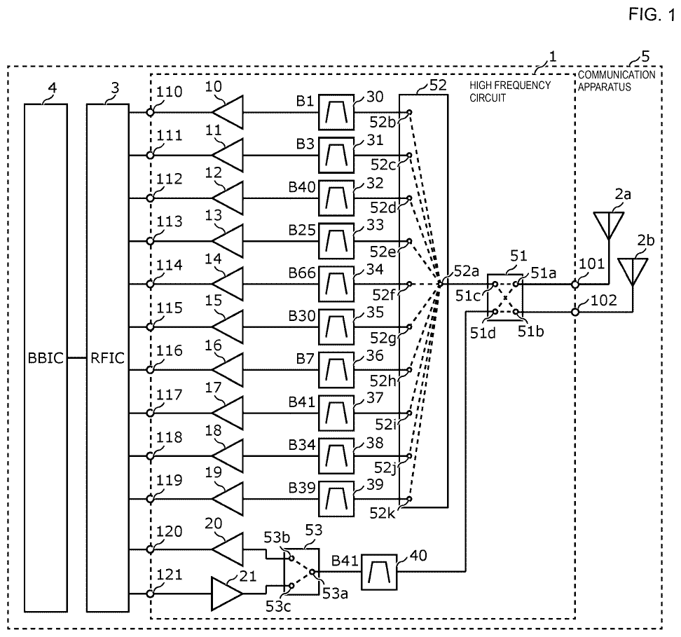

Circuit configurations of the communication apparatus 5 and the radio frequency circuit 1 according to this embodiment will be described with reference to FIG. 1. FIG. 1 is a circuit configuration diagram of the radio frequency circuit 1 and the communication apparatus 5 according to this embodiment.

FIG. 1 illustrates illustrative circuit configurations, and the radio frequency circuit 1 and the communication apparatus 5 can be implemented using any of a variety of circuit implementations and circuit technologies. Therefore, explanation for the radio frequency circuit 1 and the communication apparatus 5 provided below is not to be interpreted in a limiting manner.

### 1.1 Circuit Configuration of Communication Apparatus 5

First, a circuit configuration of the communication apparatus 5 according to this embodiment will be described with reference to FIG. 1. The communication apparatus 5 is mounted in a UE and includes the radio frequency circuit 1, antennas 2a and 2b, a radio frequency integrated circuit (RFIC) 3, and a baseband integrated circuit (BBIC) 4.

The radio frequency circuit 1 is capable of transmitting radio frequency signals between the antennas 2a and 2b and the RFIC 3. A circuit configuration of the hi radio gh frequency circuit 1 will be described later.

The antennas 2a and 2b are connected to antenna connection terminals 101 and 102, respectively, of the radio frequency circuit 1. Each of the antennas 2a and 2b is capable of receiving a radio frequency signal from outside of the communication apparatus 5 and supplying the radio frequency signal to the radio frequency circuit 1. Furthermore, each of the antennas 2a and 2b is capable of transmitting a radio frequency signal supplied from the radio frequency circuit 1 to the outside of the communication apparatus 5. The antenna 2a and/or the antenna 2b is not necessarily included in the communication apparatus 5. Furthermore, the communication apparatus 5 may further include one or more antennas, in addition to the antennas 2a and 2b.

The RFIC 3 is an example of a signal processing circuit that processes a radio frequency signal. Specifically, the RFIC 3 is capable of performing, by down-conversion or other processing, signal processing for a high-frequency reception signal input through a reception path for the radio frequency circuit 1 and supplying a reception signal generated by the signal processing to the BBIC 4. Furthermore, the RFIC 3 is capable of performing, by up-conversion or other processing, signal processing for a transmission signal input from the BBIC 4 and supplying a high-frequency transmission signal generated by the signal processing to the radio frequency circuit 1. Furthermore, the RFIC 3 may include a controller for controlling a switch, an amplifier, and the like included in the radio frequency circuit 1. Part of or the entire controller may be provided outside the RFIC 3, for example, in the BBIC 4 or the radio frequency circuit 1. The BBIC 4 is a baseband signal processing circuit that performs signal processing using a frequency range lower than the frequency of a radio frequency signal transmitted by the radio frequency circuit 1. Signals processed by the BBIC 4 include, for example, an image signal for image display and/or an audio signal for conversation using a speaker. The BBIC 4 is not necessarily included in the communication apparatus 5.

The functionality of the elements disclosed herein (including the RFIC and BBIC) may be implemented using circuitry or processing circuitry which includes general purpose processors, special purpose processors, integrated circuits, ASICs (“Application Specific Integrated Circuits”), FPGAs (“Field Programmable Gate Arrays”), conventional circuitry and/or combinations thereof which are programmed, using one or more programs stored in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein which is programmed or configured to carry out the recited functionality.

### 1.2 Circuit Configuration of Radio Frequency Circuit 1

Next, the circuit configuration of the radio frequency circuit 1 according to this embodiment will be described with reference to FIG. 1. The radio frequency circuit 1 includes low noise amplifiers 10 to 20, a power amplifier 21, filters 30 to 40, switch circuits 51 to 53, the antenna connection terminals 101 and 102, radio frequency output terminals 110 to 120, and a radio frequency input terminal 121.

The antenna connection terminals 101 and 102 are examples of a first antenna connection terminal and a second antenna connection terminal, respectively, and are external connection terminals for the radio frequency circuit 1. Specifically, the antenna connection terminals 101 and 102 are connected to the antennas 2a and 2b, respectively, outside the radio frequency circuit 1 and are connected to the switch circuit 51 inside the radiofrequency circuit 1. Thus, the radio frequency circuit 1 can supply a transmission signal through the antenna connection terminal 101 to the antenna 2a and receive a reception signal through the antenna connection terminal 101 from the antenna 2a. Furthermore, the radio frequency circuit 1 can supply a transmission signal through the antenna connection terminal 102 to the antenna 2b and receive a reception signal through the antenna connection terminal 102 from the antenna 2b.

Each of the radio frequency output terminals 110 to 120 is an external connection terminal for the radio frequency circuit 1. Specifically, the radio frequency output terminals 110 to 120 are connected to the RFIC 3 outside the radio frequency circuit 1 and are connected to the low noise amplifiers 10 to 20, respectively, inside the radio frequency circuit 1.

The radio frequency input terminal 121 is an external connection terminal for the radio frequency circuit 1. Specifically, the radio frequency input terminal 121 is connected to the RFIC 3 outside the radio frequency circuit 1 and is connected to the power amplifier 21 inside the radio frequency circuit 1.

The low noise amplifiers 10 to 20 are capable of amplifying reception signals by using power supplied from a power supply. The low noise amplifier 17 is an example of a first low noise amplifier. The low noise amplifier 20 is an example of a second low noise amplifier. Each of the low noise amplifiers 10 to 16, 18, and 19 is an example of a third low noise amplifier. Input ends of the low noise amplifiers 10 to 19 are connected to the filters 30 to 39, respectively, and output ends of the low noise amplifiers 10 to 19 are connected to the radio frequency output terminals 110 to 119, respectively. An input end of the low noise amplifier 20 is connected to the filter 40 with the switch circuit 53 interposed therebetween, and an output end of the low noise amplifier 20 is connected to the radio frequency output terminal 120.

The low noise amplifiers 10 to 20 may include field effect transistors (FETs) and may be made of semiconductor materials. The semiconductor materials may be, for example, silicon single crystal, gallium nitride (GaN), or silicon carbide (SiC). Amplifying transistors in the low noise amplifiers 10 to 20 are not limited to FETs. For example, part of or all of the low noise amplifiers 10 to 20 may be bipolar transistors.

Part of or all of the low noise amplifiers 10 to 20 are not necessarily included in the radio frequency circuit 1. In this case, part of or all of the low noise amplifiers 10 to 20 may be connected between the radio frequency output terminals and the RFIC 3 or may be included in the RFIC 3.

The power amplifier 21 is capable of amplifying a transmission signal by using power supplied from a power supply. An input end of the power amplifier 21 is connected to the radio frequency input terminal 121, and an output end of the power amplifier 21 is connected to the filter 40 with the switch circuit 53 interposed therebetween.

The power amplifier 21 may be a heterojunction bipolar transistor (HBT) and may be made of a semiconductor material. The semiconductor material may be, for example, silicon germanium (SiGe) or gallium arsenide (GaAs). An amplifying transistor in the power amplifier 21 is not limited to an HBT. For example, the power amplifier 21 may include a high electron mobility transistor (HEMT) or a metal-semiconductor field effect transistor (MESFET). In this case, the semiconductor material may be gallium nitride (GaN) or silicon carbide (SiC).

The power amplifier 21 is not necessarily included in the radio frequency circuit 1. In this case, the power amplifier 21 may be connected between the RFIC 3 and the radio frequency input terminal 121 or may be included in the RFIC 3.

The filter 30 is an example of a third filter and is a band pass filter having a pass band including a reception band of Band 1 for LTE or n1 for 5G NR (“Band 1” and “n1” may be written as “B1” without any distinction). The filter 30 is connected between the switch circuit 52 and the low noise amplifier 10. Specifically, one end of the filter 30 is connected to a selection terminal 52b of the switch circuit 52, and the other end of the filter 30 is connected to the input end of the low noise amplifier 10.

The filter 31 is an example of a third filter and is a band pass filter having a pass band including a reception band of Band 3 for LTE or n3 for 5G NR (“Band 3” and “n3” may be written as “B3” without any distinction). The filter 31 is connected between the switch circuit 52 and the low noise amplifier 11. Specifically, one end of the filter 31 is connected to a selection terminal 52c of the switch circuit 52, and the other end of the filter 31 is connected to the input end of the low noise amplifier 11.

The filter 32 is an example of a third filter and is a band pass filter having a pass band including a reception band of Band 40 for LTE or n40 for 5G NR (“Band 40” and “n40” may be written as “B40” without any distinction). The filter 32 is connected between the switch circuit 52 and the low noise amplifier 12. Specifically, one end of the filter 32 is connected to a selection terminal 52d of the switch circuit 52, and the other end of the filter 32 is connected to the input end of the low noise amplifier 12.

The filter 33 is an example of a third filter and is a band pass filter having a pass band including a reception band of Band 25 for LTE or n25 for 5G NR (“Band 25” and “n25” may be written as “B25” without any distinction). The filter 33 is connected between the switch circuit 52 and the low noise amplifier 13. Specifically, one end of the filter 33 is connected to a selection terminal 52e of the switch circuit 52, and the other end of the filter 33 is connected to the input end of the low noise amplifier 13.

The filter 34 is an example of a third filter and is a band pass filter having a pass band including a reception band of Band 66 for LTE or n66 for 5G NR (“Band 66” and “n66” may be written as “B66” without any distinction). The filter 34 is connected between the switch circuit 52 and the low noise amplifier 14. Specifically, one end of the filter 34 is connected to a selection terminal 52f of the switch circuit 52, and the other end of the filter 34 is connected to the input end of the low noise amplifier 14.

The filter 35 is an example of a third filter and is a band pass filter having a pass band including a reception band of Band 30 for LTE or n30 for 5G NR (“Band 30” and “n30” may be written as “B30” without any distinction). The filter 35 is connected between the switch circuit 52 and the low noise amplifier 15. Specifically, one end of the filter 35 is connected to a selection terminal 52g of the switch circuit 52, and the other end of the filter 35 is connected to the input end of the low noise amplifier 15.

The filter 36 is an example of a third filter and is a band pass filter having a pass band including a reception band of Band 7 for LTE or n7 for 5G NR (“Band 7” and “n7” may be written as “B7” without any distinction). The filter 36 is connected between the switch circuit 52 and the low noise amplifier 16. Specifically, one end of the filter 36 is connected to a selection terminal 52h of the switch circuit 52, and the other end of the filter 36 is connected to the input end of the low noise amplifier 16.

The filter 37 is an example of a first filter and is a band pass filter having a pass band including a reception band of Band 41 for LTE or n41 for 5G NR (“Band 41” and “n41” may be written as “B41” without any distinction). The filter 37 is connected between the switch circuit 52 and the low noise amplifier 17. Specifically, one end of the filter 37 is connected to a selection terminal 52i of the switch circuit 52, and the other end of the filter 37 is connected to the input end of the low noise amplifier 17.

The filter 38 is an example of a third filter and is a band pass filter having a pass band including a reception band of Band 34 for LTE or n34 for 5G NR (“Band 34” and “n34” may be written as “B34” without any distinction). The filter 38 is connected between the switch circuit 52 and the low noise amplifier 18. Specifically, one end of the filter 38 is connected to a selection terminal 52j of the switch circuit 52, and the other end of the filter 38 is connected to the input end of the low noise amplifier 18.

The filter 39 is an example of a third filter and is a band pass filter having a pass band including a reception band of Band 39 for LTE or n39 for 5G NR (“Band 39” and “n39” may be written as “B39” without any distinction). The filter 39 is connected between the switch circuit 52 and the low noise amplifier 19. Specifically, one end of the filter 39 is connected to a selection terminal 52k of the switch circuit 52, and the other end of the filter 39 is connected to the input end of the low noise amplifier 19.

The filter 40 is an example of a second filter and is a band pass filter having a pass band including a transmission band and a reception band of Band 41 for LTE or n41 for 5G NR. The filter 40 is connected between the switch circuit 51 and the switch circuit 53. Specifically, one end of the filter 40 is connected to a selection terminal 51d of the switch circuit 51, and the other end of the filter 40 is connected to the low noise amplifier 20 and the power amplifier 21 with the switch circuit 53 interposed therebetween in a manner in which switching between the low noise amplifier 20 and the power amplifier 21 can be performed.

The filters 30 to 40 described above may be surface acoustic wave (SAW) filters, bulk acoustic wave (BAW) filters, LC resonance filters, dielectric resonance filters, or any combination of these filters. The filters 30 to 40 are not limited to the filters mentioned above.

B41 (5150 MHz to 5925 MHz) is an example of a first band and is a band for TDD. Each of B1 (DL: 2110 MHz to 2170 MHz, UL: 1920 MHz to 1980 MHz), B3 (DL: 1805 MHz to 1880 MHz, UL: 1710 MHz to 1785 MHz), B40 (2300 MHz to 2400 MHz), B25 (DL: 1930 MHz to 1995 MHz, UL: 1850 MHz to 1915 MHz), B66 (DL: 2110 MHz to 2200 MHz, UL: 1710 MHz to 1780 MHz), B30 (DL: 2350 MHz to 2360 MHz, UL: 2305 MHz to 2315 MHz), B7 (DL: 2620 MHz to 2690 MHz, UL: 2500 MHz to 2570 MHz), B34 (2010 MHz to 2025 MHz), and B39 (1880 MHz to 1920 MHz) is an example of a second band and is a band for FDD or TDD.

A combination of B41 and any one of B1, B3, B40, B25, B66, B30, B34, and B39 is a band combination (2 bands) capable of simultaneous reception. A combination of B41 and any two of B1, B3, and B40 is a band combination (3 bands) capable of simultaneous reception. A combination of B41 and any two of B25, B66, and B30 is a band combination (3 bands) capable of simultaneous reception. A combination of B41, B34, and B39 is a band combination (3 bands) capable of simultaneous reception. A combination of B41, B1, B3, and B40 is a band combination (4 bands) capable of simultaneous reception. A combination of B41, B25, B66, and B30 is a band combination (4 bands) capable of simultaneous reception.

Part of the filters 30 to 36, 38, and 39 is not necessarily included in the radio frequency circuit 1. In this case, part of the low noise amplifiers 10 to 16, 18, and 19, which are connected to part of the filters 30 to 36, 38, and 39, and part of the radio frequency output terminals 110 to 116, 118, and 119 are not necessarily included in the radio frequency circuit 1.

The switch circuit 51 is an example of a first switch circuit and is connected between the antenna connection terminals 101 and 102, and the switch circuit 52 and the filter 40. Specifically, the switch circuit 51 includes common terminals 51a and 51b and selection terminals 51c and 51d. The common terminal 51a is an example of a first common terminal and is connected to the antenna connection terminal 101. The common terminal 51b is an example of a second common terminal and is connected to the antenna connection terminal 102. The selection terminal 51c is an example of a first selection terminal and is connected to a common terminal 52a of the switch circuit 52. The selection terminal 51d is an example of a second selection terminal and is connected to the filter 40.

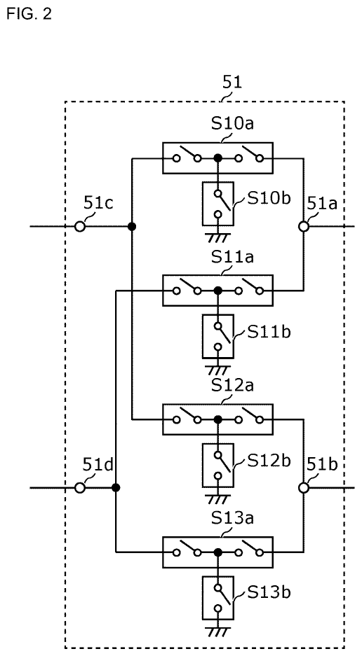

With this configuration, the switch circuit 51 allows the common terminals 51a and 51b to be connected to the selection terminals 51c and 51d, for example, on the basis of a control signal from the RFIC 3. The internal configuration of the switch circuit 51 will be described later with reference to FIG. 2.

The switch circuit 52 is an example of a second switch circuit and is connected between the switch circuit 51 and the filters 30 to 39. Specifically, the switch circuit 52 includes the common terminal 52a and the selection terminals 52b to 52k. The common terminal 52a is an example of a third common terminal and is connected to the selection terminal 51c of the switch circuit 51. The selection terminal 52i is an example of a third selection terminal and is connected to the filter 37. The selection terminals 52b to 52h, 52j, and 52k are each an example of a fourth selection terminal and are connected to the filters 30 to 36, 38, and 39, respectively.

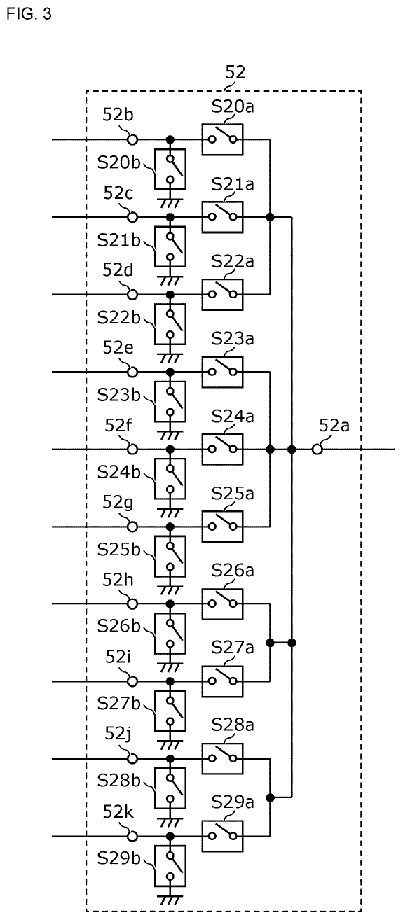

With this configuration, the switch circuit 52 allows the common terminal 52a to be connected simultaneously to any combination of the selection terminals 52b to 52k, for example, on the basis of a control signal from the RFIC 3. The internal configuration of the switch circuit 52 will be described later with reference to FIG. 3.

The switch circuit 53 is an example of a third switch circuit and is connected between the filter 40, and the low noise amplifier 20 and the power amplifier 21. Specifically, the switch circuit 53 includes a common terminal 53a and selection terminals 53b and 53c. The common terminal 53a is an example of a fourth common terminal and is connected to the filter 40. The selection terminal 53b is an example of a fifth selection terminal and is connected to the low noise amplifier 20. The selection terminal 53c is an example of a sixth selection terminal and is connected to the power amplifier 21.

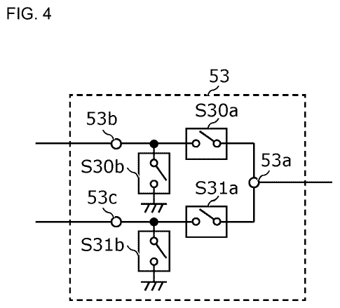

With this configuration, the switch circuit 53 allows the common terminal 53a to be connected to the selection terminals 53b and 53c, for example, on the basis of a control signal from the RFIC 3. The internal configuration of the switch circuit 53 will be described later with reference to FIG. 4.

The switch circuits 51 to 53 described above may be implemented using, for example, a plurality of discrete components. Furthermore, for example, the switch circuits 51 to 53 may be implemented using one or a plurality of integrated circuits. In this case, any combination of the switch circuits 51 to 53 may be included in a single integrated circuit.

### 1.3 Circuit Configuration of Switch Circuit 51

Next, a circuit configuration of the switch circuit 51 will be described with reference to FIG. 2. FIG. 2 is a circuit configuration diagram of the switch circuit 51 in this embodiment.

FIG. 2 illustrates an illustrative circuit configuration, and the switch circuit 51 can be implemented using any of a variety of circuit implementations and circuit technologies. Therefore, explanation for the switch circuit 51 provided below is not to be interpreted in a limiting manner.

The switch circuit 51 is a switch circuit of a double-pole double-throw (DPDT) type and includes switches S10a to S13a, switches S10b to S13b, the common terminals 51a and 51b, and the selection terminals 51c and 51d.

The switch S10a is an example of a first switch and is connected between the common terminal 51a and the selection terminal 51c. The switch S10a is capable of switching between connection and disconnection between the common terminal 51a and the selection terminal 51c.

The switch S11a is connected between the common terminal 51a and the selection terminal 51d. The switch S11a is capable of switching between connection and disconnection between the common terminal 51a and the selection terminal 51d.

The switch S12a is connected between the common terminal 51b and the selection terminal 51c. The switch S12a is capable of switching between connection and disconnection between the common terminal 51b and the selection terminal 51c.

The switch S13a is an example of a second switch and is connected between the common terminal 51b and the selection terminal 51d. The switch S13a is capable of switching between connection and disconnection between the common terminal 51b and the selection terminal 51d.

The switch S10b is connected between a path connecting the common terminal 51a to the selection terminal 51c and the ground. Specifically, the switch S10b is connected between a path connecting two semiconductor elements that are connected in series to each other and included in the switch S10a and the ground. The switch S10b is capable of switching between connection and disconnection between the path and the ground.

The switch S11b is connected between a path connecting the common terminal 51a to the selection terminal 51d and the ground. Specifically, the switch S11b is connected between a path connecting two semiconductor elements that are connected in series to each other and included in the switch S11a and the ground. The switch S11b is capable of switching between connection and disconnection between the path and the ground.

The switch S12b is connected between a path connecting the common terminal 51b to the selection terminal 51c and the ground. Specifically, the switch S12b is connected between a path connecting two semiconductor elements that are connected in series to each other and included in the switch S12a and the ground. The switch S12b is capable of switching between connection and disconnection between the path and the ground.

The switch S13b is connected between a path connecting the common terminal 51b to the selection terminal 51d and the ground. Specifically, the switch S13b is connected between a path connecting two semiconductor elements that are connected in series to each other and included in the switch S13a and the ground. The switch S13b is capable of switching between connection and disconnection between the path and the ground.

The switches S10a to S13a are single-pole single-throw (SPST) switches of a so-called series type, and the switches S10b to S13b are SPST switches of a so-called shunt type. Each of the switches S10a to S13a and S10b to S13b includes one or more semiconductor elements that are connected in series. Each of the one or more semiconductor elements is, for example, a field effect transistor (FET). In each of the switches S10a to S13a and S10b to S13b, the number of the one or more semiconductor elements that are connected in series is defined as the number of stacks.

With this configuration, the switch circuit 51 allows the common terminals 51a and 51b to be connected to the selection terminals 51c and 51d, for example, on the basis of a control signal from the RFIC 3. For example, in the case where the common terminal 51a is connected to the selection terminal 51c and the common terminal 51b is connected to the selection terminal 51d, the switches S10a and S13a and the switches S11b and S12b are closed and the switches S11a and S12a and the switches S10b and S13b are opened. Furthermore, for example, in the case where the common terminal 51a is connected to the selection terminal 51d and the common terminal 51b is connected to the selection terminal 51c, the switches S11a and S12a and the switches S10b and S13b are closed and the switches S10a and S13a and the switches S11b and S12b are opened.

In the switch circuit 51, the common terminal 51a may be unable to be connected to the selection terminal 51d and the common terminal 51b may be unable to be connected to the selection terminal 51c. In this case, the switch circuit 51 does not necessarily include the switch S11a, S11b, S12a, or S12b.

### 1.4 Circuit Configuration of Switch Circuit 52

Next, a circuit configuration of the switch circuit 52 will be described with reference to FIG. 3. FIG. 3 is a circuit configuration diagram of the switch circuit 52 in this embodiment.

FIG. 3 illustrates an illustrative circuit configuration, and the switch circuit 52 can be implemented using any of a variety of circuit implementations and circuit technologies. Therefore, explanation for the switch circuit 52 provided below is not to be interpreted in a limiting manner.

The switch circuit 52 is a switch circuit of a multi-connection type and includes switches S20a to S29a, switches S20b to S29b, the common terminal 52a, and the selection terminals 52b to 52k.

The switch S20a is an example of a fourth switch and is connected between the common terminal 52a and the selection terminal 52b. The switch S20a is capable of switching between connection and disconnection between the common terminal 52a and the selection terminal 52b.

The switch S21a is an example of a fourth switch and is connected between the common terminal 52a and the selection terminal 52c. The switch S21a is capable of switching between connection and disconnection between the common terminal 52a and the selection terminal 52c.

The switch S22a is an example of a fourth switch and is connected between the common terminal 52a and the selection terminal 52d. The switch S22a is capable of switching between connection and disconnection between the common terminal 52a and the selection terminal 52d.

The switch S23a is an example of a fourth switch and is connected between the common terminal 52a and the selection terminal 52e. The switch S23a is capable of switching between connection and disconnection between the common terminal 52a and the selection terminal 52e.

The switch S24a is an example of a fourth switch and is connected between the common terminal 52a and the selection terminal 52f. The switch S24a is capable of switching between connection and disconnection between the common terminal 52a and the selection terminal 52f.

The switch S25a is an example of a fourth switch and is connected between the common terminal 52a and the selection terminal 52g. The switch S25a is capable of switching between connection and disconnection between the common terminal 52a and the selection terminal 52g.

The switch S26a is an example of a fourth switch and is connected between the common terminal 52a and the selection terminal 52h. The switch S26a is capable of switching between connection and disconnection between the common terminal 52a and the selection terminal 52h.

The switch S27a is an example of a third switch and is connected between the common terminal 52a and the selection terminal 52i. The switch S27a is capable of switching between connection and disconnection between the common terminal 52a and the selection terminal 52i.

The switch S28a is an example of a fourth switch and is connected between the common terminal 52a and the selection terminal 52j. The switch S28a is capable of switching between connection and disconnection between the common terminal 52a and the selection terminal 52j.

The switch S29a is an example of a fourth switch and is connected between the common terminal 52a and the selection terminal 52k. The switch S29a is capable of switching between connection and disconnection between the common terminal 52a and the selection terminal 52k.

The switch S20b is connected between a path connecting the common terminal 52a to the selection terminal 52b and the ground. Specifically, the switch S20b is connected between a path connecting the switch S20a to the selection terminal 52b and the ground. The switch S20b is capable of switching between connection and disconnection between the path and the ground.

The switch S21b is connected between a path connecting the common terminal 52a to the selection terminal 52c and the ground. Specifically, the switch S21b is connected between a path connecting the switch S21a to the selection terminal 52c and the ground. The switch S21b is capable of switching between connection and disconnection between the path and the ground.

The switch S22b is connected between a path connecting the common terminal 52a to the selection terminal 52d and the ground. Specifically, the switch S22b is connected between a path connecting the switch S22a to the selection terminal 52d and the ground. The switch S22b is capable of switching between connection and disconnection between the path and the ground.

The switch S23b is connected between a path connecting the common terminal 52a to the selection terminal 52e and the ground. Specifically, the switch S23b is connected between a path connecting the switch S23a to the selection terminal 52e and the ground. The switch S23b is capable of switching between connection and disconnection between the path and the ground.

The switch S24b is connected between a path connecting the common terminal 52a to the selection terminal 52f and the ground. Specifically, the switch S24b is connected between a path connecting the switch S24a to the selection terminal 52f and the ground. The switch S24b is capable of switching between connection and disconnection between the path and the ground.

The switch S25b is connected between a path connecting the common terminal 52a to the selection terminal 52g and the ground. Specifically, the switch S25b is connected between a path connecting the switch S25a to the selection terminal 52g and the ground. The switch S25b is capable of switching between connection and disconnection between the path and the ground.

The switch S26b is connected between a path connecting the common terminal 52a to the selection terminal 52h and the ground. Specifically, the switch S26b is connected between a path connecting the switch S26a to the selection terminal 52h and the ground. The switch S26b is capable of switching between connection and disconnection between the path and the ground.

The switch S27b is connected between a path connecting the common terminal 52a to the selection terminal 52i and the ground. Specifically, the switch S27b is connected between a path connecting the switch S27a to the selection terminal 52i and the ground. The switch S27b is capable of switching between connection and disconnection between the path and the ground.

The switch S28b is connected between a path connecting the common terminal 52a to the selection terminal 52j and the ground. Specifically, the switch S28b is connected between a path connecting the switch S28a to the selection terminal 52j and the ground. The switch S28b is capable of switching between connection and disconnection between the path and the ground.

The switch S29b is connected between a path connecting the common terminal 52a to the selection terminal 52k and the ground. Specifically, the switch S29b is connected between a path connecting the switch S29a to the selection terminal 52k and the ground. The switch S29b is capable of switching between connection and disconnection between the path and the ground.

The switches S20a to S29a are SPST switches of a so-called series type, and the switches S20b to S29b are SPST switches of a so-called shunt type. Each of the switches S20a to S29a and S20b to S29b includes one or more semiconductor elements that are connected in series. Each of the one or more semiconductor elements is, for example, an FET. In each of the switches S20a to S29a and S20b to S29b, the number of the one or more semiconductor elements that are connected in series is defined as the number of stacks.

Here, the number of stacks of each of the switches S20a to S29a may be smaller than the number of stacks of each of the switches S10a to S13a. That is, the number of stacks of each of the SPST switches of the series type included in the switch circuit 52 may be smaller than the number of stacks of each of the SPST switches of the series type included in the switch circuit 51. This is because, although the switch circuit 51 includes a transmission path, the switch circuit 52 does not include a transmission path, and the withstand voltage of the switch circuit 52 thus does not need to be as high as the withstand voltage of the switch circuit 51.

With this configuration, the switch circuit 52 allows the common terminal 52a to be connected simultaneously to any combination of the selection terminals 52b to 52k, for example, on the basis of a control signal from the RFIC 3. For example, in the case where the common terminal 52a is connected simultaneously to the selection terminals 52b, 52c, and 52i, the switches S20a, S21a, and S27a and the switches S22b to S26b, S28b, and S29b are closed and the switches S22a to S26a, S28a, and S29a and the switches S20b, S21b, and S27b are opened. Furthermore, the switch circuit 52 can also allow the common terminal 52a to be connected to only one of the selection terminals 52b to 52k. For example, in the case where the common terminal 52a is connected only to the selection terminal 52i, the switch S27a and the switches S20b to S26b, S28b, and S29b are closed and the switches S20a to S26a, S28a, and S29a and the switch S27b are opened.

### 1.5 Circuit Configuration of Switch Circuit 53

Next, a circuit configuration of the switch circuit 53 will be described with reference to FIG. 4. FIG. 4 is a circuit configuration diagram of the switch circuit 53 in this embodiment.

FIG. 4 illustrates an illustrative circuit configuration, and the switch circuit 53 can be implemented using any of a variety of circuit implementations and circuit technologies. Therefore, explanation for the switch circuit 53 provided below is not to be interpreted in a limiting manner.

The switch circuit 53 is a switch circuit of a single-pole double-throw (SPDT) type and includes switches S30a and S31a, switches S30b and S31b, the common terminal 53a, and the selection terminals 53b and 53c.

The switch S30a is connected between the common terminal 53a and the selection terminal 53b. The switch S30a is capable of switching between connection and disconnection between the common terminal 53a and the selection terminal 53b.

The switch S31a is connected between the common terminal 53a and the selection terminal 53c. The switch S31a is capable of switching between connection and disconnection between the common terminal 53a and the selection terminal 53c.

The switch S30b is connected between a path connecting the common terminal 53a to the selection terminal 53b and the ground. Specifically, the switch S30b is connected between a path connecting the switch S30a to the selection terminal 53b and the ground. The switch S30b is capable of switching between connection and disconnection between the path and the ground.

The switch S31b is connected between a path connecting the common terminal 53a to the selection terminal 53c and the ground. Specifically, the switch S31b is connected between a path connecting the switch S31a to the selection terminal 53c and the ground. The switch S31b is capable of switching between connection and disconnection between the path and the ground.

The switches S30a and S31a are SPST switches of a so-called series type, and the switches S30b and S31b are SPST switches of a so-called shunt type. Each of the switches S30a, S31a, S30b, and S31b includes one or more semiconductor elements that are connected in series. Each of the one or more semiconductor elements is, for example, an FET.

With this configuration, the switch circuit 53 allows the common terminal 53a to be connected exclusively to the selection terminal 53b or 53c, for example, on the basis of a control signal from the RFIC 3. For example, in the case where the common terminal 53a is connected to the selection terminal 53b, the switch S30a and the switch S31b are closed and the switch S31a and the switch S30b are opened. Furthermore, for example, in the case where the common terminal 53a is connected to the selection terminal 53c, the switch S31a and the switch S30b are closed and the switch S30a and the switch S31b are opened.

### 1.6 Communication Modes of Communication Apparatus 5

Next, a plurality of communication modes that can be used in the communication apparatus 5 will be described.

### [1.6.1 First Communication Mode]

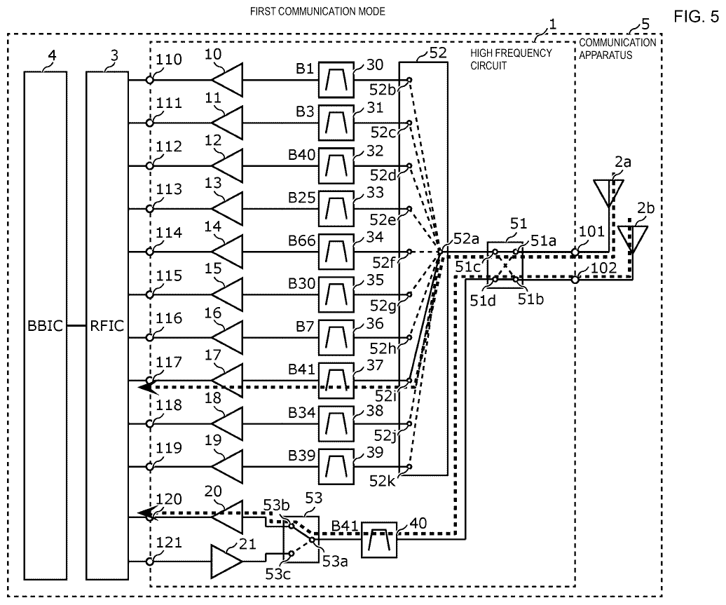

First, a first communication mode will be described with reference to FIG. 5. FIG. 5 is a diagram illustrating the first communication mode of the communication apparatus 5 according to this embodiment. In FIG. 5 and subsequent figures, broken-line arrows indicate flow of radio frequency signals.

In the first communication mode, the communication apparatus 5 is capable of receiving two reception signals in B41 at the different antennas 2a and 2b at the same time. Accordingly, multiple-input and multiple-output (MIMO) in B41 can be achieved.

As illustrated in FIG. 5, in the first communication mode, the switch circuit 51 connects the common terminal 51a to the selection terminal 51c but not to the selection terminal 51d and connects the common terminal 51b to the selection terminal 51d but not to the selection terminal 51c. Furthermore, the switch circuit 52 connects the common terminal 52a to the selection terminal 52i but not to the selection terminal 52b, 52c, 52d, 52e, 52f, 52g, 52h, 52j, or 52k. Furthermore, the switch circuit 53 connects the common terminal 53a to the selection terminal 53b but not to the selection terminal 53c. Thus, the low noise amplifier 17 and the filter 37 are connected to the antenna connection terminal 101, and the low noise amplifier 20 and the filter 40 are connected to the antenna connection terminal 102.

As a result, one of the reception signals in B41 is transmitted from the antenna 2a, through the antenna connection terminal 101, the switch circuit 51, the switch circuit 52, the filter 37, the low noise amplifier 17, and the radio frequency output terminal 117, to the RFIC 3. Furthermore, the other one of the reception signals in B41 is transmitted from the antenna 2b, through the antenna connection terminal 102, the switch circuit 51, the filter 40, the switch circuit 53, the low noise amplifier 20, and the radio frequency output terminal 120, to the RFIC 3.

In the first communication mode, the low noise amplifier 17 and the filter 37 may be connected to the antenna connection terminal 102, and the low noise amplifier 20 and the filter 40 may be connected to the antenna connection terminal 101. In this case, the switch circuit 51 can connect the common terminal 51a to the selection terminal 51d and connect the common terminal 51b to the selection terminal 51c.

### [1.6.2 Second Communication Mode]

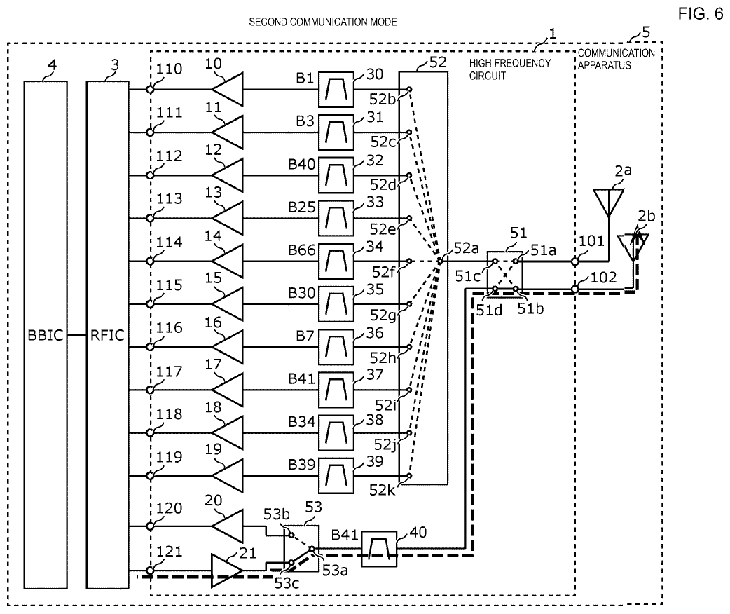

Next, a second communication mode will be described with reference to FIG. 6. FIG. 6 is a diagram illustrating the second communication mode of the communication apparatus 5 according to this embodiment.

In the second communication mode, the communication apparatus 5 is capable of transmitting a transmission signal in B41. As illustrated in FIG. 6, in the second communication mode, the switch circuit 51 does not connect the common terminal 51a to the selection terminal 51c or 51d and connects the common terminal 51b to the selection terminal 51d but not to the selection terminal 51c. Furthermore, the switch circuit 53 connects the common terminal 53a to the selection terminal 53c but not to the selection terminal 53b. Thus, the power amplifier 21 and the filter 40 are connected to the antenna connection terminal 102.

As a result, the transmission signal in B41 is transmitted from the RFIC 3, through the radio frequency input terminal 121, the power amplifier 21, the switch circuit 53, the filter 40, the switch circuit 51, and the antenna connection terminal 102, to the antenna 2b.

In the second communication mode, the power amplifier 21 and the filter 40 may be connected to the antenna connection terminal 101. In this case, the switch circuit 51 can connect the common terminal 51a to the selection terminal 51d.

### [1.6.3 Third Communication Mode]

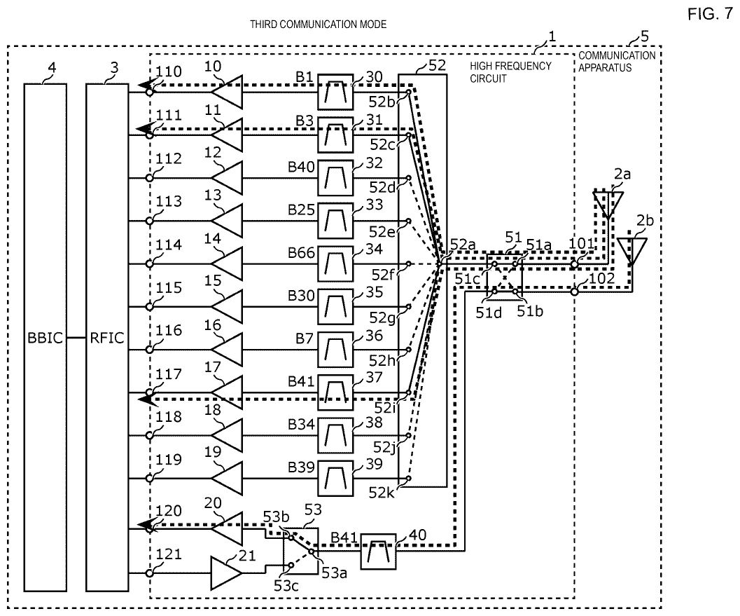

Next, a third communication mode will be described with reference to FIG. 7. FIG. 7 is a diagram illustrating the third communication mode of the communication apparatus 5 according to this embodiment.

In the third communication mode, the communication apparatus 5 is capable of receiving two reception signals in B41 and reception signals in B1 and B3 at the two antennas 2a and 2b at the same time. Accordingly, MIMO in B41 and CA, EN-DC, NR-DC, or NE-DC in B1, B3, and B41 can be achieved at the same time.

As illustrated in FIG. 7, in the third communication mode, the switch circuit 51 connects the common terminal 51a to the selection terminal 51c but not to the selection terminal 51d and connects the common terminal 51b to the selection terminal 51d but not to the selection terminal 51c. Furthermore, the switch circuit 52 connects the common terminal 52a to the selection terminals 52b, 52c, and 52i but not to the selection terminal 52d, 52e, 52f, 52g, 52h, 52j, or 52k. Furthermore, the switch circuit 53 connects the common terminal 53a to the selection terminal 53b but not to the selection terminal 53c. Thus, the low noise amplifier 10 and the filter 30, the low noise amplifier 11 and the filter 31, and the low noise amplifier 17 and the filter 37 are connected to the antenna connection terminal 101, and the low noise amplifier 20 and the filter 40 are connected to the antenna connection terminal 102.

As a result, one of the reception signals in B41 is transmitted from the antenna 2a, through the antenna connection terminal 101, the switch circuit 51, the switch circuit 52, the filter 37, the low noise amplifier 17, and the radio frequency output terminal 117, to the RFIC 3. Furthermore, the other one of the reception signals in B41 is transmitted from the antenna 2b, through the antenna connection terminal 102, the switch circuit 51, the filter 40, the switch circuit 53, the low noise amplifier 20, and the radio frequency output terminal 120, to the RFIC 3. The reception signal in B1 is transmitted from the antenna 2a, through the antenna connection terminal 101, the switch circuit 51, the switch circuit 52, the filter 30, the low noise amplifier 10, and the radio frequency output terminal 110, to the RFIC 3. The reception signal in B3 is transmitted from the antenna 2a, through the antenna connection terminal 101, the switch circuit 51, the switch circuit 52, the filter 31, the low noise amplifier 11, and the radio frequency output terminal 111, to the RFIC 3.

In the third communication mode, the low noise amplifier 10 and the filter 30, the low noise amplifier 11 and the filter 31, and the low noise amplifier 17 and the filter 37 may be connected to the antenna connection terminal 102, and the low noise amplifier 20 and the filter 40 may be connected to the antenna connection terminal 101. In this case, the switch circuit 51 can connect the common terminal 51a to the selection terminal 51d and connect the common terminal 51b to the selection terminal 51c.

Furthermore, in the third communication mode, bands of reception signals that are received simultaneously with the two reception signals in B41 are not limited to B1 and B3. For example, bands of reception signals that are received simultaneously with the two reception signals in B41 may be one of or any combination of B1, B3, and B40, may be one of or any combination of B25, B66, and B30, or may be one or both of B34 and B39.

### [1.6.4 Fourth Communication Mode]

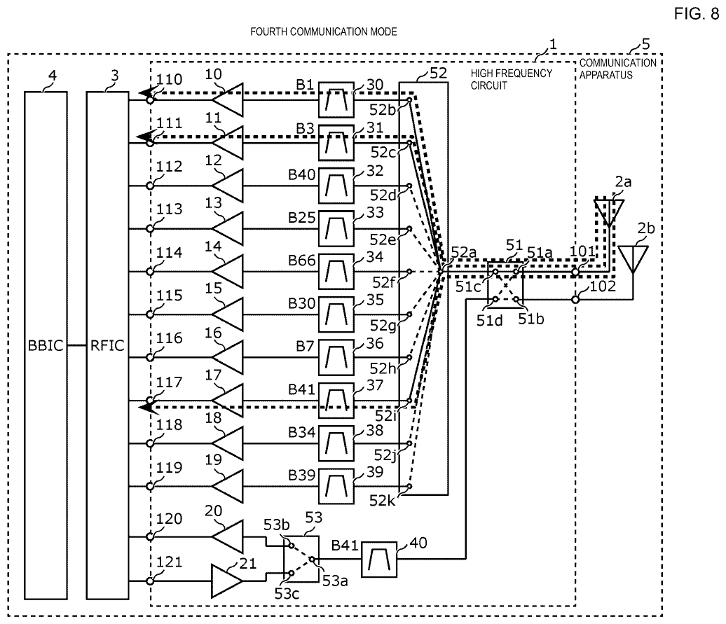

Next, a fourth communication mode will be described with reference to FIG. 8. FIG. 8 is a diagram illustrating the fourth communication mode of the communication apparatus 5 according to this embodiment.

In the fourth communication mode, the communication apparatus 5 is capable of receiving a reception signal in B41 and reception signals in B1 and B3 at the same time. Accordingly, CA, EN-DC, NR-DC, or NE-DC in B1, B3, and B41 can be achieved.

As illustrated in FIG. 8, in the fourth communication mode, the switch circuit 51 connects the common terminal 51a to the selection terminal 51c but not to the selection terminal 51d and does not connect the common terminal 51b to the selection terminal 51c or 51d. Furthermore, the switch circuit 52 connects the common terminal 52a to the selection terminals 52b, 52c, and 52i but not to the selection terminal 52d, 52e, 52f, 52g, 52h, 52j, or 52k. Thus, the low noise amplifier 10 and the filter 30, the low noise amplifier 11 and the filter 31, and the low noise amplifier 17 and the filter 37 are connected to the antenna connection terminal 101.

As a result, the reception signal in B41 is transmitted from the antenna 2a, through the antenna connection terminal 101, the switch circuit 51, the switch circuit 52, the filter 37, the low noise amplifier 17, and the radio frequency output terminal 117, to the RFIC 3. The reception signal in B1 is transmitted from the antenna 2a, through the antenna connection terminal 101, the switch circuit 51, the switch circuit 52, the filter 30, the low noise amplifier 10, and the radio frequency output terminal 110, to the RFIC 3. The reception signal in B3 is transmitted from the antenna 2a, through the antenna connection terminal 101, the switch circuit 51, the switch circuit 52, the filter 31, the low noise amplifier 11, and the radio frequency output terminal 111, to the RFIC 3.

In the fourth communication mode, the low noise amplifier 10 and the filter 30, the low noise amplifier 11 and the filter 31, and the low noise amplifier 17 and the filter 37 may be connected to the antenna connection terminal 102. In this case, the switch circuit 51 can connect the common terminal 51b to the selection terminal 51c.

Furthermore, in the fourth communication mode, bands of reception signals that are received simultaneously with the reception signal in B41 are not limited to B1 and B3. For example, bands of reception signals that are received simultaneously with the reception signal in B41 may be one of or any combination of B1, B3, and B40, may be one of or any combination of B25, B66, and B30, or may be one or both of B34 and B39.

### [1.6.5 Fifth Communication Mode]

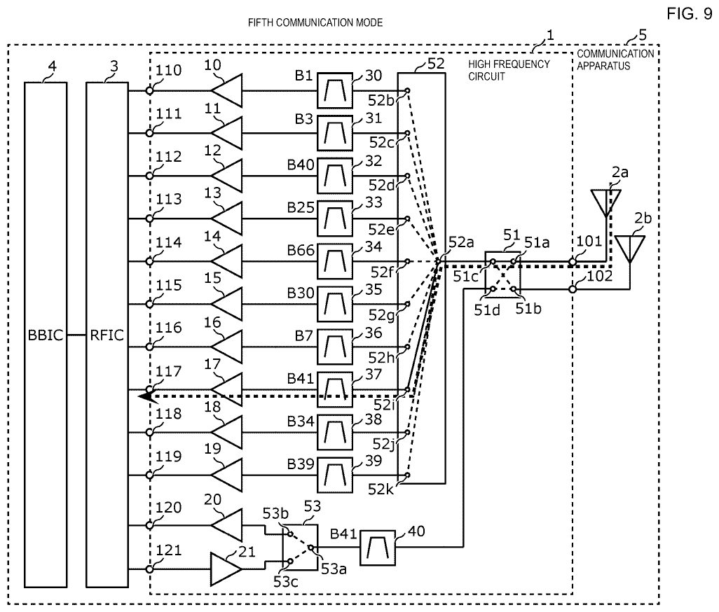

Next, a fifth communication mode will be described with reference to FIG. 9. FIG. 9 is a diagram illustrating the fifth communication mode of the communication apparatus 5 according to this embodiment.

In the fifth communication mode, the communication apparatus 5 is capable of receiving a reception signal in B41. As illustrated in FIG. 9, in the fifth communication mode, the switch circuit 51 connects the common terminal 51a to the selection terminal 51c but not to the selection terminal 51d and does not connect the common terminal 51b to the selection terminal 51c or 51d. Furthermore, the switch circuit 52 connects the common terminal 52a to the selection terminal 52i but not to the selection terminal 52b, 52c, 52d, 52e, 52f, 52g, 52h, 52j, or 52k. Thus, the low noise amplifier 17 and the filter 37 are connected to the antenna connection terminal 101.

As a result, the reception signal in B41 is transmitted from the antenna 2a, through the antenna connection terminal 101, the switch circuit 51, the switch circuit 52, the filter 37, the low noise amplifier 17, and the radio frequency output terminal 117, to the RFIC 3.

In the fifth communication mode, the low noise amplifier 17 and the filter 37 may be connected to the antenna connection terminal 102. In this case, the switch circuit 51 can connect the common terminal 51b to the selection terminal 51c.

### 1.7 Effects and Others

As described above, the radio frequency circuit 1 according to this embodiment includes the power amplifier 21, the low noise amplifiers 17, 20, and 10, the switch circuit 51 including the common terminal 51a connected to the antenna connection terminal 101, the common terminal 51b connected to the antenna connection terminal 102, and the selection terminals 51c and 51d, the switch circuit 52 including the common terminal 52a connected to the selection terminal 51c and the selection terminals 52i and 52b, the switch circuit 53 including the common terminal 53a, the selection terminal 53b connected to the low noise amplifier 20, and the selection terminal 53c connected to the power amplifier 21, the filter 37 connected between the selection terminal 52i and the low noise amplifier 17 and having a pass band including a first band for TDD, the filter 40 connected between the selection terminal 51d and the common terminal 53a and having a pass band including the first band, and the filter 30 connected between the selection terminal 52b and the low noise amplifier 10 and having a pass band including at least part of a second band.

Accordingly, since the filter 37 for reception of a signal in the first band and the filter 40 for transmission and reception of a signal in the first band are included, the radio frequency circuit 1 can deal with simultaneous reception of two reception signals in the first band and transmission of a transmission signal in the first band. In the radio frequency circuit 1 described above, since the plurality of filters 37 and 30 for reception are connected to the switch circuit 51 with the switch circuit 52 interposed therebetween, the number of selection terminals in the switch circuit 51 to which the filter 40 for transmission and reception is connected can be reduced. Thus, signal loss in a transmission path in the switch circuit 51 can be reduced. Furthermore, if the switch circuit 52 does not include a transmission path, the withstand voltage of the switch circuit 52 can be lower than the withstand voltage of the switch circuit 51, and miniaturization of the switch circuit 52 can thus be achieved. Thus, miniaturization of the switch circuits 51 and 52 as a whole can be achieved, and miniaturization of the radio frequency circuit 1 can thus be achieved. In particular, in the case where more filters for reception are connected to the switch circuit 52, miniaturization mentioned above is highly effective. Furthermore, since the filter 40 can be used for both transmission and reception, a reduction in the number of filters also contributes to miniaturization of the radio frequency circuit 1.

Furthermore, for example, in the radio frequency circuit 1 according to this embodiment, in the first communication mode in which two reception signals in the first band are received simultaneously, (i) the switch circuit 51 may connect the common terminal 51a to the selection terminal 51c and connect the common terminal 51b to the selection terminal 51d, (ii) the switch circuit 52 may connect the common terminal 52a to the selection terminal 52i, and (iii) the switch circuit 53 may connect the common terminal 53a to the selection terminal 53b.

Accordingly, two reception signals in the first band can be received simultaneously through the two antenna connection terminals 101 and 102.

Furthermore, for example, in the radio frequency circuit 1 according to this embodiment, in the second communication mode in which a transmission signal in the first band is transmitted, (iv) the switch circuit 51 may connect the common terminal 51b to the selection terminal 51d, and (v) the switch circuit 53 may connect the common terminal 53a to the selection terminal 53c.

Accordingly, transmission of a transmission signal in the first band can be achieved.

Furthermore, for example, in the radio frequency circuit 1 according to this embodiment, in the third communication mode in which two reception signals in the first band and a reception signal in the second band are received simultaneously, (vi) the switch circuit 51 may connect the common terminal 51a to the selection terminal 51c and connect the common terminal 51b to the selection terminal 51d, (vii) the switch circuit 52 may connect the common terminal 52a to the selection terminals 52i and 52b, and (viii) the switch circuit 53 may connect the common terminal 53a to the selection terminal 53b.

Accordingly, simultaneous reception of two reception signals in the first band and a reception signal in the second band can be achieved.

Furthermore, for example, in the radio frequency circuit 1 according to this embodiment, in the fourth communication mode in which a reception signal in the first band and a reception signal in the second band are received simultaneously, (ix) the switch circuit 51 may connect the common terminal 51a to the selection terminal 51c, and (x) the switch circuit 52 may connect the common terminal 52a to the selection terminals 52i and 52b.

Accordingly, simultaneous reception of a reception signal in the first band and a reception signal in the second band can be achieved. At this time, since the filter 37 dedicated to reception can be used for reception of the first band, the quality of a reception signal in the first band can be improved compared to the case where the filter 40 for both transmission and reception is used.

Furthermore, for example, in the radio frequency circuit 1 according to this embodiment, in the fifth communication mode in which a reception signal in the first band is received, (xi) the switch circuit 51 may connect the common terminal 51a to the selection terminal 51c, and (xii) the switch circuit 52 may connect the common terminal 52a to the selection terminal 52i.

Accordingly, single reception of a reception signal in the first band can be achieved. At this time, since the filter 37 dedicated to reception can be used for reception of the first band, the quality of a reception signal in the first band can be improved compared to the case where the filter 40 for both transmission and reception is used.

Furthermore, for example, in the radio frequency circuit 1 according to this embodiment, the switch circuit 51 may include the switch S10a connected between the common terminal 51a and the selection terminal 51c and the switch S13a connected between the common terminal 51b and the selection terminal 51d, the switch circuit 52 may include the switch S27a connected between the common terminal 52a and the selection terminal 52i and the switch S20a connected between the common terminal 52a and the selection terminal 52b, and the number of stacks of each of the switches S27a and S20a may be smaller than the number of stacks of each of the switches S10a and S13a.

Accordingly, since the number of stacks of each of the switches S27a and S20a included in the switch circuit 52 is smaller than the number of stacks of each of the switches S10a and S13a included in the switch circuit 51, miniaturization of the switch circuit 52 can be achieved.

Furthermore, for example, in the radio frequency circuit 1 according to this embodiment, the first band may be Band 41 for LTE or n41 for 5G NR, and the second band may be Band 1, Band 3, Band 40, Band 25, Band 66, Band 30, Band 7, Band 34, or Band 39 for LTE or n1, n3, n40, n25, n66, n30, n7, n34, or n39 for 5G NR.

Accordingly, the radio frequency circuit 1 can support LTE and/or 5G NR.

Furthermore, the communication apparatus 5 according to this embodiment includes the RFIC 3 that processes a radio frequency signal and the radio frequency circuit 1 that transmits a radio frequency signal between the RFIC 3 and the antennas 2a and 2b.

Accordingly, in the communication apparatus 5, effects similar to those achieved in the radio frequency circuit 1 can be achieved.

### Second Embodiment

Next, a second embodiment will be described. This embodiment is different from the first embodiment described above mainly in that the filter 40 for transmission and reception of signals in the first band (B41) is divided into a filter for transmission and a filter for reception. Features of this embodiment that are different from the embodiment described above will be mainly described below with reference to drawings.

A communication apparatus 5A according to this embodiment is similar to the communication apparatus 5 according to the first embodiment with the exception that a radio frequency circuit 1A is provided in place of the radio frequency circuit 1. Therefore, explanation for the communication apparatus 5A will be omitted.

### 2.1 Circuit Configuration of Radio Frequency Circuit 1A

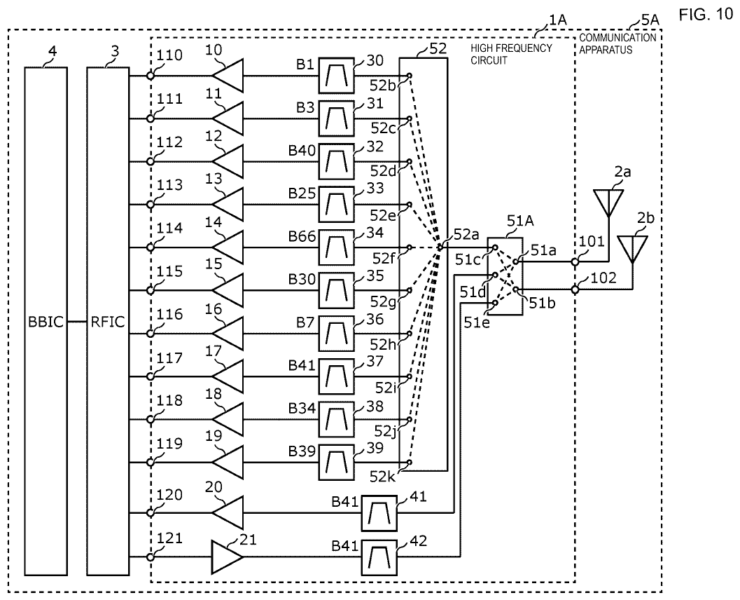

A circuit configuration of the radio frequency circuit 1A according to this embodiment will be described with reference to FIG. 10. FIG. 10 is a circuit configuration diagram of the radio frequency circuit 1A and the communication apparatus 5A according to this embodiment.

FIG. 10 illustrates illustrative circuit configurations, and the radio frequency circuit 1A can be implemented using any of a variety of circuit implementations and circuit technologies. Therefore, explanation for the radio frequency circuit 1A provided below is not to be interpreted in a limiting manner.

The radio frequency circuit 1A includes low noise amplifiers 10 to 20, a power amplifier 21, filters 30 to 39, 41, and 42, switch circuits 51A and 52, antenna connection terminals 101 and 102, radio frequency output terminals 110 to 120, and a radio frequency input terminal 121.

The filter 41 is an example of a second filter and is a band pass filter having a pass band including a reception band of B41. The filter 41 is connected between the switch circuit 51A and the low noise amplifier 20. Specifically, one end of the filter 41 is connected to a selection terminal 51d of the switch circuit 51A, and the other end of the filter 41 is connected to the low noise amplifier 20.

The filter 42 is an example of a third filter and is a band pass filter having a pass band including a transmission band of B41. The filter 42 is connected between the switch circuit 51A and the power amplifier 21. Specifically, one end of the filter 42 is connected to a selection terminal 51e of the switch circuit 51A, and the other end of the filter 42 is connected to the power amplifier 21.

The filters 41 and 42 described above may be SAW filters, BAW filters, LC resonance filters, dielectric resonance filters, or any combination of these filters. The filters 41 and 42 are not limited to the filters mentioned above.

In this embodiment, the filters 30 to 36, 38, and 39 are each an example of a fourth filter.

The switch circuit 51A is an example of a first switch circuit and is connected between the antenna connection terminals 101 and 102, and the switch circuit 52 and the filters 41 and 42. Specifically, the switch circuit 51A includes common terminals 51a and 51b and selection terminals 51c to 51e. The common terminal 51a is an example of a first common terminal and is connected to the antenna connection terminal 101. The common terminal 51b is an example of a second common terminal and is connected to the antenna connection terminal 102. The selection terminal 51c is an example of a first selection terminal and is connected to a common terminal 52a of the switch circuit 52. The selection terminal 51d is an example of a second selection terminal and is connected to the filter 41. The selection terminal 51e is an example of a third selection terminal and is connected to the filter 42.

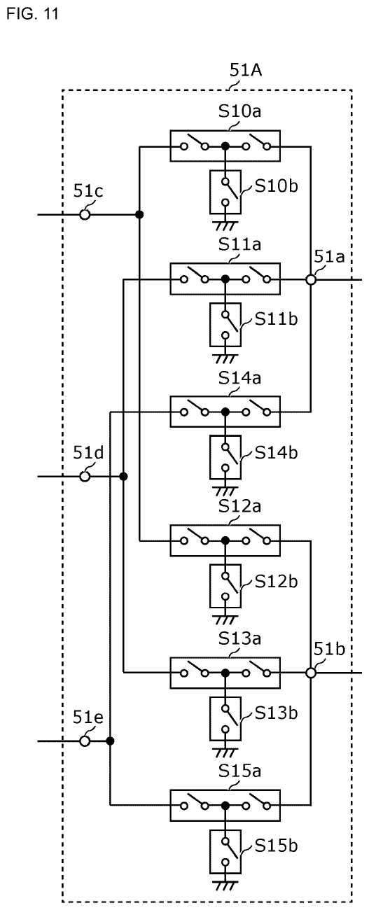

With this configuration, the switch circuit 51A allows the common terminals 51a and 51b to be connected to the selection terminals 51c to 51e, for example, on the basis of a control signal from the RFIC 3. The internal configuration of the switch circuit 51A will be described later with reference to FIG. 11.

The switch circuit 52 is an example of a second switch circuit and is connected between the switch circuit 51A and the filters 30 to 39. Specifically, the switch circuit 52 includes the common terminal 52a and selection terminals 52b to 52k. The common terminal 52a is an example of a third common terminal and is connected to the selection terminal 51c of the switch circuit 51A. The selection terminal 52i is an example of a fourth selection terminal and is connected to the filter 37. The selection terminals 52b to 52h, 52j, and 52k are each an example of a fifth selection terminal and are connected to the filters 30 to 36, 38, and 39, respectively.

With this configuration, the switch circuit 52 allows the common terminal 52a to be connected simultaneously to any combination of the selection terminals 52b to 52k, for example, on the basis of a control signal from the RFIC 3.

The switch circuits 51A and 52 described above may be implemented using, for example, a plurality of discrete components. Furthermore, for example, the switch circuits 51A and 52 may be implemented using, for example, one or a plurality of integrated circuits. In this case, the switch circuits 51A and 52 may be included in a single integrated circuit.

### 2.2 Circuit Configuration of Switch Circuit 51A

Next, a circuit configuration of the switch circuit 51A will be described with reference to FIG. 11. FIG. 11 is a circuit configuration diagram of the switch circuit 51A in this embodiment.

FIG. 11 illustrates an illustrative circuit configuration, and the switch circuit 51A can be implemented using any of a variety of circuit implementations and circuit technologies. Therefore, explanation for the switch circuit 51A provided below is not to be interpreted in a limiting manner.

The switch circuit 51A is a switch circuit of a double-pole triple-throw (DP3T) type and includes switches S10a to S15a, switches S10b to S15b, the common terminals 51a and 51b, and the selection terminals 51c to 51e.

The switch S14a is connected between the common terminal 51a and the selection terminal 51e. The switch S14a is capable of switching between connection and disconnection between the common terminal 51a and the selection terminal 51e.

The switch S15a is an example of a fifth switch and is connected between the common terminal 51b and the selection terminal 51e. The switch S15a is capable of switching between connection and disconnection between the common terminal 51b and the selection terminal 51e.

The switch S14b is connected between a path connecting the common terminal 51a to the selection terminal 51e and the ground. Specifically, the switch S14b is connected between a path connecting two semiconductor elements that are connected in series to each other and included in the switch S14a and the ground. The switch S14b is capable of switching between connection and disconnection between the path and the ground.

The switch S15b is connected between a path connecting the common terminal 51b to the selection terminal 51e and the ground. Specifically, the switch S15b is connected between a path connecting two semiconductor elements that are connected in series to each other and included in the switch S15a and the ground. The switch S15b is capable of switching between connection and disconnection between the path and the ground.

The switches S10a to S15a are SPST switches of a so-called series type, and the switches S10b to S15b are SPST switches of a so-called shunt type. Each of the switches S10a to S15a and S10b to S15b includes one or more semiconductor elements that are connected in series. Each of the one or more semiconductor elements is, for example, an FET. In each of the switches S10a to S15a and S10b to S15b, the number of the one or more semiconductor elements that are connected in series is defined as the number of stacks.

With this configuration, the switch circuit 51A allows the common terminals 51a and 51b to be connected to the selection terminals 51c to 51e, for example, on the basis of a control signal from the RFIC 3.

In the switch circuit 51A, the common terminal 51a may be unable to be connected to the selection terminal 51d or 51e and the common terminal 51b may be unable to be connected to the selection terminal 51c. In this case, the switch circuit 51A does not necessarily include the switch S11a, S11b, S12a, S12b, S13a, or S13b.

In this embodiment, the switch S27a is an example of a fourth switch, and each of the switches S20a to S26a, S28a, and S29a is an example of a fifth switch. The number of stacks of each of the switches S20a to S29a may be smaller than the number of stacks of each of the switches S10a to S15a. That is, the number of stacks of each of the SPST switches of the series type included in the switch circuit 52 may be smaller than the number of stacks of each of the SPST switches of the series type included in the switch circuit 51A. This is because, although the switch circuit 51A includes a transmission path, the switch circuit 52 does not include a transmission path, and the withstand voltage of the switch circuit 52 thus does not need to be as high as the withstand voltage of the switch circuit 51A.

### 2.3 Communication Modes of Communication Apparatus 5A

Next, a plurality of communication modes that can be used in the communication apparatus 5A will be described.

### [2.3.1 First Communication Mode]

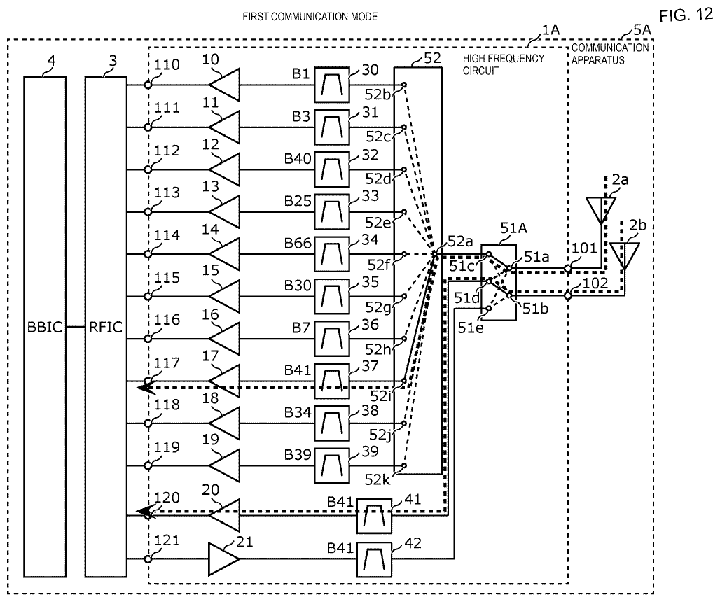

First, a first communication mode will be described with reference to FIG. 12. FIG. 12 is a diagram illustrating the first communication mode of the communication apparatus 5A according to this embodiment.

In the first communication mode, the communication apparatus 5A is capable of receiving two reception signals in B41 at the different antennas 2a and 2b at the same time. Accordingly, MIMO in B41 can be achieved.

As illustrated in FIG. 12, in the first communication mode, the switch circuit 51A connects the common terminal 51a to the selection terminal 51c but not to the selection terminal 51d or 51e and connects the common terminal 51b to the selection terminal 51d but not to the selection terminal 51c or 51e. Furthermore, the switch circuit 52 connects the common terminal 52a to the selection terminal 52i but not to the selection terminal 52b, 52c, 52d, 52e, 52f, 52g, 52h, 52j, or 52k. Thus, the low noise amplifier 17 and the filter 37 are connected to the antenna connection terminal 101, and the low noise amplifier 20 and the filter 41 are connected to the antenna connection terminal 102.

As a result, one of the reception signals in B41 is transmitted from the antenna 2a, through the antenna connection terminal 101, the switch circuit 51A, the switch circuit 52, the filter 37, the low noise amplifier 17, and the radio frequency output terminal 117, to the RFIC 3. Furthermore, the other one of the reception signals in B41 is transmitted from the antenna 2b, through the antenna connection terminal 102, the switch circuit 51A, the filter 41, the low noise amplifier 20, and the radio frequency output terminal 120, to the RFIC 3.

In the first communication mode, the low noise amplifier 17 and the filter 37 may be connected to the antenna connection terminal 102, and the low noise amplifier 20 and the filter 41 may be connected to the antenna connection terminal 101. In this case, the switch circuit 51A can connect the common terminal 51a to the selection terminal 51d and connect the common terminal 51b to the selection terminal 51c.

### [2.3.2 Second Communication Mode]

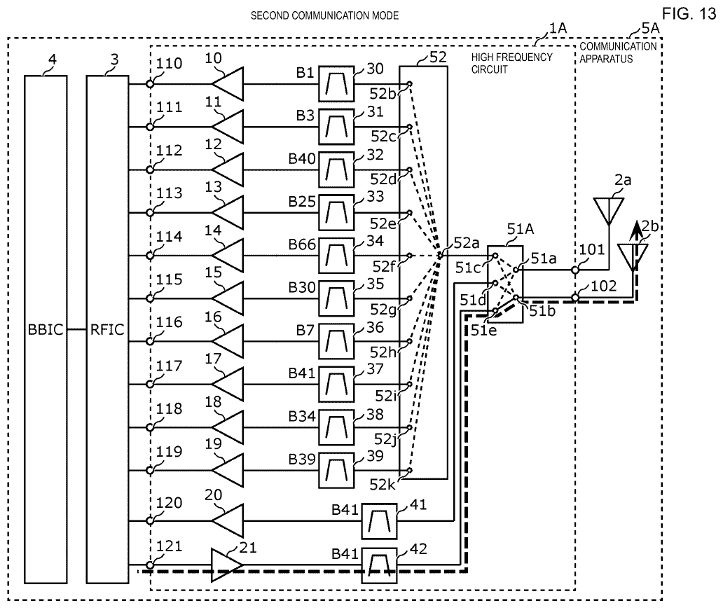

Next, a second communication mode will be described with reference to FIG. 13. FIG. 13 is a diagram illustrating the second communication mode of the communication apparatus 5A according to this embodiment.

In the second communication mode, the communication apparatus 5A is capable of transmitting a transmission signal in B41. As illustrated in FIG. 13, in the second communication mode, the switch circuit 51A does not connect the common terminal 51a to the selection terminal 51c, 51d, or 51e and connects the common terminal 51b to the selection terminal 51e but not to the selection terminal 51c or 51d. Thus, the power amplifier 21 and the filter 42 are connected to the antenna connection terminal 102.

As a result, the transmission signal in B41 is transmitted from the RFIC 3, through the radio frequency input terminal 121, the power amplifier 21, the filter 42, the switch circuit 51A, and the antenna connection terminal 102, to the antenna 2b.

In the second communication mode, the power amplifier 21 and the filter 42 may be connected to the antenna connection terminal 101. In this case, the switch circuit 51A can connect the common terminal 51a to the selection terminal 51e.

### [2.3.3 Third Communication Mode]

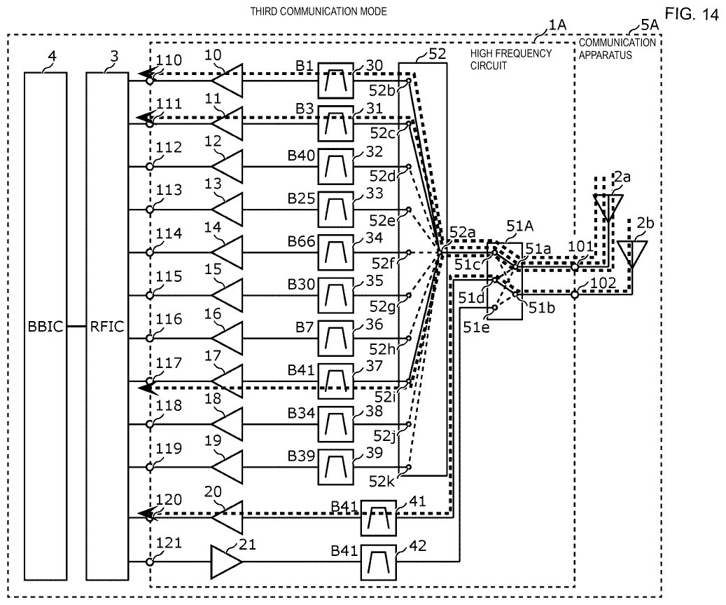

Next, a third communication mode will be described with reference to FIG. 14. FIG. 14 is a diagram illustrating the third communication mode of the communication apparatus 5A according to this embodiment.

In the third communication mode, the communication apparatus 5A is capable of receiving two reception signals in B41 and reception signals in B1 and B3 at the two antennas 2a and 2b at the same time. Accordingly, MIMO in B41 and CA, EN-DC, NR-DC, or NE-DC in B1, B3, and B41 can be achieved at the same time.

As illustrated in FIG. 14, in the third communication mode, the switch circuit 51A connects the common terminal 51a to the selection terminal 51c but not to the selection terminal 51d or 51e and connects the common terminal 51b to the selection terminal 51d but not to the selection terminal 51c or 51e. Furthermore, the switch circuit 52 connects the common terminal 52a to the selection terminals 52b, 52c, and 52i but not to the selection terminal 52d, 52e, 52f, 52g, 52h, 52j, or 52k. Thus, the low noise amplifier 10 and the filter 30, the low noise amplifier 11 and the filter 31, and the low noise amplifier 17 and the filter 37 are connected to the antenna connection terminal 101, and the low noise amplifier 20 and the filter 41 are connected to the antenna connection terminal 102.

As a result, one of the reception signals in B41 is transmitted from the antenna 2a, through the antenna connection terminal 101, the switch circuit 51A, the switch circuit 52, the filter 37, the low noise amplifier 17, and the radio frequency output terminal 117, to the RFIC 3. Furthermore, the other one of the reception signals in B41 is transmitted from the antenna 2b, through the antenna connection terminal 102, the switch circuit 51A, the filter 41, the low noise amplifier 20, and the radio frequency output terminal 120, to the RFIC 3. The reception signal in B1 is transmitted from the antenna 2a, through the antenna connection terminal 101, the switch circuit 51A, the switch circuit 52, the filter 30, the low noise amplifier 10, and the radio frequency output terminal 110, to the RFIC 3. The reception signal in B3 is transmitted from the antenna 2a, through the antenna connection terminal 101, the switch circuit 51A, the switch circuit 52, the filter 31, the low noise amplifier 11, and the radio frequency output terminal 111, to the RFIC 3.

In addition, in the third communication mode, the low noise amplifier 10 and the filter 30, the low noise amplifier 11 and the filter 31, and the low noise amplifier 17 and the filter 37 may be connected to the antenna connection terminal 102, and the low noise amplifier 20 and the filter 41 may be connected to the antenna connection terminal 101. In this case, the switch circuit 51A can connect the common terminal 51a to the selection terminal 51d and connect the common terminal 51b to the selection terminal 51c.

Furthermore, in the third communication mode, bands of reception signals that are received simultaneously with the two reception signals in B41 are not limited to B1 and B3. For example, bands of reception signals that are received simultaneously with the two reception signals in B41 may be only one of B1 and B3. Furthermore, for example, bands of reception signals that are received simultaneously with the two reception signals in B41 may be B40, may be one or both of B25 and B66, may be B34, or may be B39.

### [2.3.4 Fourth Communication Mode]

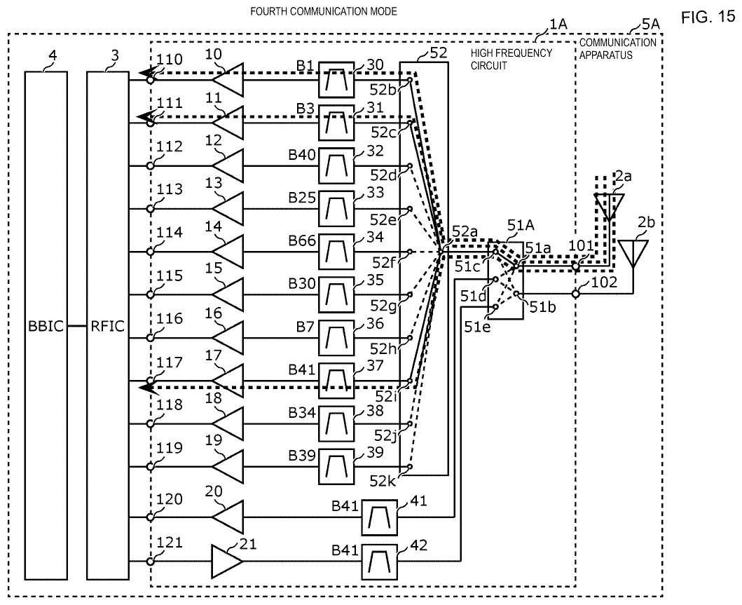

Next, a fourth communication mode will be described with reference to FIG. 15. FIG. 15 is a diagram illustrating the fourth communication mode of the communication apparatus 5A according to this embodiment.

In the fourth communication mode, the communication apparatus 5A is capable of receiving a reception signal in B41 and reception signals in B1 and B3 at the same time. Accordingly, CA, EN-DC, NR-DC, or NE-DC in B1, B3, and B41 can be achieved.

As illustrated in FIG. 15, in the fourth communication mode, the switch circuit 51A connects the common terminal 51a to the selection terminal 51c but not to the selection terminal 51d or 51e and does not connect the common terminal 51b to the selection terminal 51c, 51d, or 51e. Furthermore, the switch circuit 52 connects the common terminal 52a to the selection terminals 52b, 52c, and 52i but not to the selection terminal 52d, 52e, 52f, 52g, 52h, 52j, or 52k. Thus, the low noise amplifier 10 and the filter 30, the low noise amplifier 11 and the filter 31, and the low noise amplifier 17 and the filter 37 are connected to the antenna connection terminal 101.

As a result, the reception signal in B41 is transmitted from the antenna 2a, through the antenna connection terminal 101, the switch circuit 51A, the switch circuit 52, the filter 37, the low noise amplifier 17, and the radio frequency output terminal 117, to the RFIC 3. The reception signal in B1 is transmitted from the antenna 2a, through the antenna connection terminal 101, the switch circuit 51A, the switch circuit 52, the filter 30, the low noise amplifier 10, and the radio frequency output terminal 110, to the RFIC 3. The reception signal in B3 is transmitted from the antenna 2a, through the antenna connection terminal 101, the switch circuit 51A, the switch circuit 52, the filter 31, the low noise amplifier 11, and the radio frequency output terminal 111, to the RFIC 3.

In the fourth communication mode, the low noise amplifier 10 and the filter 30, the low noise amplifier 11 and the filter 31, and the low noise amplifier 17 and the filter 37 may be connected to the antenna connection terminal 102. In this case, the switch circuit 51A can connect the common terminal 51b to the selection terminal 51c.

Furthermore, in the fourth communication mode, bands of reception signals that are received simultaneously with the reception signal in B41 are not limited to B1 and B3. For example, bands of reception signals that are received simultaneously with the reception signal in B41 may be only one of B1 and B3. Furthermore, for example, bands of reception signals that are received simultaneously with the reception signal in B41 may be B40, may be one or both of B25 and B66, may be B34, or may be B39.

### [2.3.5 Fifth Communication Mode]

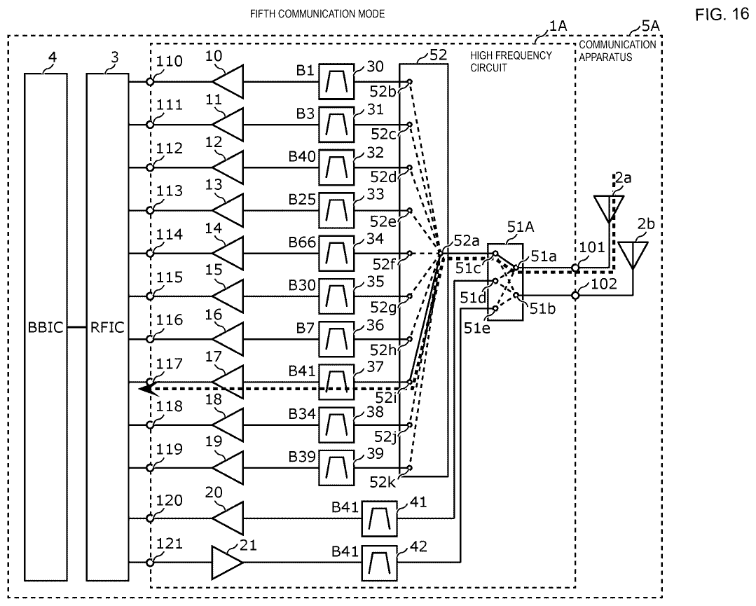

Next, a fifth communication mode will be described with reference to FIG. 16. FIG. 16 is a diagram illustrating the fifth communication mode of the communication apparatus 5A according to this embodiment.

In the fifth communication mode, the communication apparatus 5A is capable of receiving a reception signal in B41. As illustrated in FIG. 16, in the fifth communication mode, the switch circuit 51A connects the common terminal 51a to the selection terminal 51c but not to the selection terminal 51d or 51e and does not connect the common terminal 51b to the selection terminal 51c, 51d, or 51e. Furthermore, the switch circuit 52 connects the common terminal 52a to the selection terminal 52i but not to the selection terminal 52b, 52c, 52d, 52e, 52f, 52g, 52h, 52j, or 52k. Thus, the low noise amplifier 17 and the filter 37 are connected to the antenna connection terminal 101.

As a result, the reception signal in B41 is transmitted from the antenna 2a, through the antenna connection terminal 101, the switch circuit 51A, the switch circuit 52, the filter 37, the low noise amplifier 17, and the radio frequency output terminal 117, to the RFIC 3.

In the fifth communication mode, the low noise amplifier 17 and the filter 37 may be connected to the antenna connection terminal 102. In this case, the switch circuit 51A can connect the common terminal 51b to the selection terminal 51c.

### 2.4 Effects and Others

As described above, the radio frequency circuit 1A according to this embodiment includes the power amplifier 21, the low noise amplifiers 17, 20, and 10, the switch circuit 51A including the common terminal 51a connected to the antenna connection terminal 101, the common terminal 51b connected to the antenna connection terminal 102, and the selection terminals 51c, 51d, and 51e, the switch circuit 52 including the common terminal 52a connected to the selection terminal 51c and the selection terminals 52i and 52b, the filter 37 connected between the selection terminal 52i and the low noise amplifier 17 and having a pass band including a first band for TDD, the filter 41 connected between the selection terminal 51d and the low noise amplifier 20 and having a pass band including the first band, the filter 42 connected between the selection terminal 51e and the power amplifier 21 and having a pass band including the first band, and the filter 30 connected between the selection terminal 52b and the low noise amplifier 10 and having a pass band including at least part of a second band.

Accordingly, since the filters 37 and 41 for reception of signals in the first band and the filter 42 for transmission of a signal in the first band are included, the radio frequency circuit 1A can deal with simultaneous reception of two reception signals in the first band and transmission of a transmission signal in the first band. In the radio frequency circuit 1A described above, since the plurality of filters 37 and 30 for reception are connected to the switch circuit 51A with the switch circuit 52 interposed therebetween, the number of selection terminals in the switch circuit 51A to which the filter 42 for transmission is connected can be reduced. Thus, signal loss in a transmission path in the switch circuit 51A can be reduced. Furthermore, if the switch circuit 52 does not include a transmission path, the withstand voltage of the switch circuit 52 can be lower than the withstand voltage of the switch circuit 51A, and miniaturization of the switch circuit 52 can be achieved. Thus, miniaturization of the switch circuits 51A and 52 as a whole can be achieved, and miniaturization of the radio frequency circuit 1A can be achieved. In particular, in the case where more filters for reception are connected to the switch circuit 52, miniaturization mentioned above is highly effective.

Furthermore, for example, in the radio frequency circuit 1A according to this embodiment, in the first communication mode in which two reception signals in the first band are received simultaneously, (i) the switch circuit 51A may connect the common terminal 51a to the selection terminal 51c and connect the common terminal 51b to the selection terminal 51d, and (ii) the switch circuit 52 may connect the common terminal 52a to the selection terminal 52i.

Accordingly, two reception signals in the first band can be received simultaneously through the two antenna connection terminals 101 and 102.

Furthermore, for example, in the radio frequency circuit 1A according to this embodiment, in the second communication mode in which a transmission signal in the first band is transmitted, (iii) the switch circuit 51A may connect the common terminal 51b to the selection terminal 51e.

Accordingly, transmission of a transmission signal in the first band can be achieved.

Furthermore, for example, in the radio frequency circuit 1A according to this embodiment, in the third communication mode in which two reception signals in the first band and a reception signal in the second band are received simultaneously, (iv) the switch circuit 51A may connect the common terminal 51a to the selection terminal 51c and connect the common terminal 51b to the selection terminal 51d, and (v) the switch circuit 52 may connect the common terminal 52a to the selection terminals 52i and 52b.

Accordingly, simultaneous reception of two reception signals in the first band and a reception signal in the second band can be achieved.

Furthermore, for example, in the radio frequency circuit 1A according to this embodiment, in the fourth communication mode in which a reception signal in the first band and a reception signal in the second band are received simultaneously, (vi) the switch circuit 51A may connect the common terminal 51a to the selection terminal 51c, and (vii) the switch circuit 52 may connect the common terminal 52a to the selection terminals 52i and 52b.

Accordingly, simultaneous reception of a reception signal in the first band and a reception signal in the second band can be achieved.

Furthermore, for example, in the radio frequency circuit 1A according to this embodiment, in the fifth communication mode in which a reception signal in the first band is received, (viii) the switch circuit 51A may connect the common terminal 51a to the selection terminal 51c, and (ix) the switch circuit 52 may connect the common terminal 52a to the selection terminal 52i.

Accordingly, single reception of a reception signal in the first band can be achieved.

Furthermore, for example, in the radio frequency circuit 1A according to this embodiment, the switch circuit 51A may include the switch S10a connected between the common terminal 51a and the selection terminal 51c, the switch S13a connected between the common terminal 51b and the selection terminal 51d, and the switch S15a connected between the common terminal 51b and the selection terminal 51e, the switch circuit 52 may include the switch S27a connected between the common terminal 52a and the selection terminal 52i and the switch S20a connected between the common terminal 52a and the selection terminal 52b, and the number of stacks of each of the switches S27a and S20a may be smaller than the number of stacks of each of the switches S10a, S13a, and S15a.

Accordingly, since the number of stacks of each of the switches S27a and S20a included in the switch circuit 52 is smaller than the number of stacks of each of the switches S10a, S13a, and S15a included in the switch circuit 51A, miniaturization of the switch circuit 52 can be achieved.

Furthermore, for example, in the radio frequency circuit 1A according to this embodiment, the first band may be Band 41 for LTE or n41 for 5G NR, and the second band may be Band 1, Band 3, Band 40, Band 25, Band 66, Band 30, Band 7, Band 34, or Band 39 for LTE or n1, n3, n40, n25, n66, n30, n7, n34, or n39 for 5G NR.

Accordingly, the radio frequency circuit 1A can support LTE and/or 5G NR.

Furthermore, the communication apparatus 5A according to this embodiment includes the RFIC 3 that processes a radio frequency signal and the radio frequency circuit 1A that transmits a radio frequency signal between the RFIC 3 and the antennas 2a and 2b.

Accordingly, in the communication apparatus 5A, effects similar to those achieved in the radio frequency circuit 1A can be achieved.

### Other Embodiments

The radio frequency circuits and the communication apparatuses according to aspects of the present invention have been described above based on embodiments. However, a radio frequency circuit and a communication apparatus according to the present disclosure are not limited to the embodiments described above. Other embodiments implemented by combining desired component elements in embodiments described above, modifications obtained by making various changes conceivable by those skilled in the art to the embodiments described above without departing from the gist of the present invention, and various types of equipment including a radio frequency circuit described above are also included in the present invention.

For example, in the circuit configurations of a radio frequency circuit and a communication apparatus according to each of the embodiments described above, a circuit element, a wire, and the like may be inserted between circuit elements and paths connecting signal paths disclosed in the drawings. For example, an impedance matching circuit may be inserted between a low noise amplifier and a filter and/or between a power amplifier and a filter. For example, an impedance matching circuit may be inserted between a filter and a switch. At this time, although the impedance matching circuit can include, for example, an inductor and/or a capacitor, the impedance matching circuit is not particularly limited to the configuration mentioned above.

Furthermore, for example, in each of the embodiments described above, any combination of the filters 30 to 39 may be connected to one terminal of the switch circuit 52. For example, the filters 30 to 32 may be connected to one terminal, the filters 33 to 35 may be connected to one terminal, and the filters 38 and 39 may be connected to one terminal. Thus, the number of terminals in the switch circuit 52 can be reduced, and miniaturization of the switch circuit 52 can be achieved.

Furthermore, for example, in each of the embodiments described above, any combination of the radio frequency output terminals 110 to 119 may be integrated into a common radio frequency output terminal. In this case, the common radio frequency output terminal may be connected to a plurality of low noise amplifiers with a switch circuit interposed therebetween in a manner in which switching between the plurality of low noise amplifiers can be performed. Thus, the number of the radio frequency output terminals can be reduced, and miniaturization of the radio frequency circuit 1 or 1A can be achieved.

Furthermore, for example, in each of the embodiments described above, any combination of the low noise amplifiers 10 to 20 may be integrated into a common low noise amplifier. In this case, the common low noise amplifier may be connected to a plurality of filters with a switch circuit interposed therebetween in a manner in which switching between the plurality of filters can be performed. Thus, the number of the low noise amplifiers can be reduced, and miniaturization of the radio frequency circuit 1 or 1A can be achieved.

Together with another radio frequency circuit connected to another antenna, the radio frequency circuit 1 or 1A according to an embodiment described above may be used for simultaneous reception of three or more reception signals in B41 and may be used for simultaneous transmission of two or more transmission signals in B41 or transmission signals in B41 and another band. This circuit configuration may also be used for simultaneous transmission of two or more transmission signals in B41 or one or more transmission signals in B41 and a transmission signal in another band. In this case, a transmission signal in B1 or B3 may be used as a transmission signal in the other band.

Furthermore, the above embodiments may be realized by using a secondary switch for one Rx path while keeping the main Tx/Rx path on the primary switch. As used herein, a “transceiver circuit portion” refers to the circuit elements connected to the first switch circuit (51 or 51A) that provide a transmission path and a reception path for the first band. In the first embodiment (FIG. 1), the transceiver circuit portion includes the second filter 40, the third switch circuit 53, the second low noise amplifier 20, and the power amplifier 21. In this configuration, the second filter 40 is shared for both transmission and reception. In the second embodiment (FIG. 10), the transceiver circuit portion includes the second reception filter 41, the transmission filter 42, the second low noise amplifier 20, and the power amplifier 21.

Features of a radio frequency circuit and a communication apparatus described above based on each of the foregoing embodiments will be described below.

### <1>

A radio frequency circuit including:
a first switch circuit including a first common terminal connected to a first antenna connection terminal, a second common terminal connected to a second antenna connection terminal, a first selection terminal, and a second selection terminal;
a second switch circuit including a third common terminal connected to the first selection terminal, a third selection terminal, and a fourth selection terminal;
a third switch circuit including a fourth common terminal, a fifth selection terminal connected to a second low noise amplifier, and a sixth selection terminal connected to a power amplifier;
a first filter connected between the third selection terminal and a first low noise amplifier and having a pass band including a first band for TDD;
a second filter connected between the second selection terminal and the fourth common terminal and having a pass band including the first band; and
a third filter connected between the fourth selection terminal and a third low noise amplifier and having a pass band including at least part of a second band.

### <2>

The radio frequency circuit according to <1>,

wherein in a first communication mode in which two reception signals in the first band are received simultaneously,
(i) the first switch circuit connects the first common terminal to the first selection terminal and connects the second common terminal to the second selection terminal,
(ii) the second switch circuit connects the third common terminal to the third selection terminal, and
(iii) the third switch circuit connects the fourth common terminal to the fifth selection terminal.

### <3>

The radio frequency circuit according to <1> or <2>,
wherein in a second communication mode in which a transmission signal in the first band is transmitted,
(iv) the first switch circuit connects the second common terminal to the second selection terminal, and
(v) the third switch circuit connects the fourth common terminal to the sixth selection terminal.

### <4>

### The Radio Frequency Circuit According to Any One of <1> to <3>,

wherein in a third communication mode in which two reception signals in the first band and a reception signal in the second band are received simultaneously,
(vi) the first switch circuit connects the first common terminal to the first selection terminal and connects the second common terminal to the second selection terminal,
(vii) the second switch circuit connects the third common terminal to the third selection terminal and the fourth selection terminal, and
(viii) the third switch circuit connects the fourth common terminal to the fifth selection terminal.

### <5>

The radio frequency circuit according to any one of <1> to <4>,
wherein in a fourth communication mode in which a reception signal in the first band and a reception signal in the second band are received simultaneously,
(ix) the first switch circuit connects the first common terminal to the first selection terminal, and
(x) the second switch circuit connects the third common terminal to the third selection terminal and the fourth selection terminal.

### <6>

The radio frequency circuit according to any one of <1> to <5>,
wherein in a fifth communication mode in which a reception signal in the first band is received,
(xi) the first switch circuit connects the first common terminal to the first selection terminal, and
(xii) the second switch circuit connects the third common terminal to the third selection terminal.

### <7>

The radio frequency circuit according to any one of <1> to <6>,
wherein the first switch circuit includes
a first switch connected between the first common terminal and the first selection terminal, and
a second switch connected between the second common terminal and the second selection terminal,
wherein the second switch circuit includes
a third switch connected between the third common terminal and the third selection terminal, and
a fourth switch connected between the third common terminal and the fourth selection terminal, and
wherein a number of stacks of each of the third switch and the fourth switch is smaller than a number of stacks of each of the first switch and the second switch.

### <8>

The radio frequency circuit according to any one of <1> to <7>,
wherein the first band is Band 41 for LTE or n41 for 5G NR, and
wherein the second band is Band 1, Band 3, Band 40, Band 25, Band 66, Band 30, Band 7, Band 34, or Band 39 for LTE or n1, n3, n40, n25, n66, n30, n7, n34, or n39 for 5G NR.

### <9>

A communication apparatus comprising:
a signal processing circuit that processes a radio frequency signal; and
the radio frequency circuit according to any one of <1> to <8> that transmits a radio frequency signal between the signal processing circuit and an antenna.

### <10>

A radio frequency circuit comprising:
a first switch circuit including a first common terminal connected to a first antenna connection terminal, a second common terminal connected to a second antenna connection terminal, a first selection terminal, a second selection terminal, and a third selection terminal;
a second switch circuit including a third common terminal connected to the first selection terminal, a fourth selection terminal, and a fifth selection terminal;
a first filter connected between the fourth selection terminal and a first low noise amplifier and having a pass band including a first band for TDD;
a second filter connected between the second selection terminal and a second low noise amplifier and having a pass band including the first band;
a third filter connected between the third selection terminal and a power amplifier and having a pass band including the first band; and
a fourth filter connected between the fifth selection terminal and a third low noise amplifier and having a pass band including at least part of a second band.

### <11>

The radio frequency circuit according to <10>,
wherein in a first communication mode in which two reception signals in the first band are received simultaneously,
(i) the first switch circuit connects the first common terminal to the first selection terminal and connects the second common terminal to the second selection terminal, and
(ii) the second switch circuit connects the third common terminal to the fourth selection terminal.

### <12>

The radio frequency circuit according to <10> or <11>,
wherein in a second communication mode in which a transmission signal in the first band is transmitted,
(iii) the first switch circuit connects the second common terminal to the third selection terminal.

### <13>

The radio frequency circuit according to any one of <10> to <12>,
wherein in a third communication mode in which two reception signals in the first band and a reception signal in the second band are received simultaneously,
(iv) the first switch circuit connects the first common terminal to the first selection terminal and connects the second common terminal to the second selection terminal, and

(v) the second switch circuit connects the third common terminal to the fourth selection terminal and the fifth selection terminal.

### <14>

The radio frequency circuit according to any one of <10> to <13>,
wherein in a fourth communication mode in which a reception signal in the first band and a reception signal in the second band are received simultaneously,
(vi) the first switch circuit connects the first common terminal to the first selection terminal, and
(vii) the second switch circuit connects the third common terminal to the fourth selection terminal and the fifth selection terminal.

### <15>

The radio frequency circuit according to any one of <10> to <14>,
wherein in a fifth communication mode in which a reception signal in the first band is received,
(viii) the first switch circuit connects the first common terminal to the first selection terminal, and
(ix) the second switch circuit connects the third common terminal to the fourth selection terminal.

### <16>

The radio frequency circuit according to any one of <10> to <15>,
wherein the first switch circuit includes
a first switch connected between the first common terminal and the first selection terminal,
a second switch connected between the second common terminal and the second selection terminal, and
a fifth switch connected between the second common terminal and the third selection terminal,
wherein the second switch circuit includes
a third switch connected between the third common terminal and the fourth selection terminal, and
a fourth switch connected between the third common terminal and the fifth selection terminal, and
wherein a number of stacks of each of the third switch and the fourth switch is smaller than a number of stacks of each of the first switch, the second switch, and the fifth switch.

### <17>

The radio frequency circuit according to any one of <10> to <16>,
wherein the first band is Band 41 for LTE or n41 for 5G NR, and
wherein the second band is Band 1, Band 3, Band 40, Band 25, Band 66, Band 30, Band 7, Band 34, or Band 39 for LTE or n1, n3, n40, n25, n66, n30, n7, n34, or n39 for 5G NR.

### <18>

A communication apparatus comprising:
a signal processing circuit that processes a radio frequency signal; and
the radio frequency circuit according to any one of <10> to <17>that transmits a radio frequency signal between the signal processing circuit and an antenna.

### INDUSTRIAL APPLICABILITY

The present disclosure is widely usable as a radio frequency circuit arranged in a front end section for communication equipment such as a mobile phone.

### REFERENCE SIGNS LIST

1, 1A radio frequency circuit
2a, 2b antenna
3 RFIC
4 BBIC
5, 5A communication apparatus
10, 11, 12, 13, 14, 15, 16, 17, 18, 19, 20 low noise amplifier
21 power amplifier
30, 31, 32, 33, 34, 35, 36, 37, 38, 39, 40, 41, 42 filter
51, 51a, 52, 53 switch circuit
51a, 51b, 52a, 53a common terminal
51c, 51d, 51e, 52b, 52c, 52d, 52e, 52f, 52g, 52h, 52i, 52j, 52k, 53b, 53c selection terminal
101, 102 antenna connection terminal
110, 111, 112, 113, 114, 115, 116, 117, 118, 119, 120 radio frequency output terminal
121 radio frequency input terminal

1. A radio frequency circuit comprising:
a first switch circuit including a first common terminal connected to a first antenna connection terminal, a second common terminal connected to a second antenna connection terminal, a first selection terminal, and a second selection terminal;
a second switch circuit including a third common terminal connected to the first selection terminal and a third selection terminal connected to a first reception filter having a pass band including a first band; and
a transceiver circuit portion connected to the second selection terminal of the first switch circuit, the transceiver circuit portion including a transmission path for the first band and a second reception path for the first band, wherein the radio frequency circuit is configured to simultaneously receive signals in the first band via the first reception filter and the second reception path.

2. The radio frequency circuit according to claim 1, wherein the transceiver circuit portion further includes:
a third switch circuit including a fourth common terminal, a fifth selection terminal connected to a second low noise amplifier, and a sixth selection terminal connected to a power amplifier; and
a transmission/reception filter connected between the second selection terminal and the fourth common terminal, the transmission/reception filter forming both the transmission path and the second reception path.

3. The radio frequency circuit according to claim 2,
wherein in a first communication mode in which two reception signals in the first band are received simultaneously,
(i) the first switch circuit connects the first common terminal to the first selection terminal and connects the second common terminal to the second selection terminal,
(ii) the second switch circuit connects the third common terminal to the third selection terminal, and
(iii) the third switch circuit connects the fourth common terminal to the fifth selection terminal.

4. The radio frequency circuit according to claim 2, wherein in a second communication mode in which a transmission signal in the first band is transmitted,
(iv) the first switch circuit connects the second common terminal to the second selection terminal, and
(v) the third switch circuit connects the fourth common terminal to the sixth selection terminal.

5. The radio frequency circuit according to claim 1,
wherein the second switch circuit further includes a fourth selection terminal connected to a third reception filter having a pass band including at least part of a second band,
wherein in a third communication mode in which two reception signals in the first band and a reception signal in the second band are received simultaneously,
(vi) the first switch circuit connects the first common terminal to the first selection terminal and connects the second common terminal to the second selection terminal,
(vii) the second switch circuit connects the third common terminal to the third selection terminal and the fourth selection terminal, and
(viii) the third switch circuit connects the fourth common terminal to the fifth selection terminal.

6. The radio frequency circuit according to claim 5,
wherein in a fourth communication mode in which a reception signal in the first band and a reception signal in the second band are received simultaneously,
(ix) the first switch circuit connects the first common terminal to the first selection terminal, and
(x) the second switch circuit connects the third common terminal to the third selection terminal and the fourth selection terminal.

7. The radio frequency circuit according to claim 2,
wherein in a fifth communication mode in which a reception signal in the first band is received,
(xi) the first switch circuit connects the first common terminal to the first selection terminal, and
(xii) the second switch circuit connects the third common terminal to the third selection terminal.

8. The radio frequency circuit according to claim 1,
wherein the first switch circuit includes
a first switch connected between the first common terminal and the first selection terminal, and
a second switch connected between the second common terminal and the second selection terminal,
wherein the second switch circuit includes
a third switch connected between the third common terminal and the third selection terminal, and
a fourth switch connected between the third common terminal and the fourth selection terminal, and
wherein a number of stacks of each of the third switch and the fourth switch is smaller than a number of stacks of each of the first switch and the second switch.

9. The radio frequency circuit according to claim 2,
wherein the first band is Band 41 for LTE or n41 for 5G NR, and
wherein the second band is Band 1, Band 3, Band 40, Band 25, Band 66, Band 30, Band 7, Band 34, or Band 39 for LTE or n1, n3, n40, n25, n66, n30, n7, n34, or n39 for 5G NR.

10. A communication apparatus comprising:
a signal processing circuit that processes a radio frequency signal; and
the radio frequency circuit according to claim 2 that transmits a high frequency signal between the signal processing circuit and an antenna.

11. The radio frequency circuit according to claim 1, wherein
the first switch circuit further includes a third selection terminal; and
the transceiver circuit portions includes
a second reception filter connected between the second selection terminal and a second low noise amplifier and having a pass band including the first band, the second reception filter forming the second reception path;
a transmission filter connected between the third selection terminal and a power amplifier and having a pass band including the first band, the transmission filter forming the transmission path.

12. The radio frequency circuit according to claim 11,
wherein in a first communication mode in which two reception signals in the first band are received simultaneously,
(i) the first switch circuit connects the first common terminal to the first selection terminal and connects the second common terminal to the second selection terminal, and
(ii) the second switch circuit connects the third common terminal to the fourth selection terminal.

13. The radio frequency circuit according to claim 11,
wherein in a second communication mode in which a transmission signal in the first band is transmitted,
(iii) the first switch circuit connects the second common terminal to the third selection terminal.

14. The radio frequency circuit according to claim 11,
wherein the second switch circuit further includes a fourth selection terminal connected to a third reception filter having a pass band including at least part of a second band, and
wherein in a third communication mode in which two reception signals in the first band and a reception signal in the second band are received simultaneously,
(iv) the first switch circuit connects the first common terminal to the first selection terminal and connects the second common terminal to the second selection terminal, and
(v) the second switch circuit connects the third common terminal to the fourth selection terminal and the fifth selection terminal.

15. The radio frequency circuit according to claim 11,
wherein in a fourth communication mode in which a reception signal in the first band and a reception signal in the second band are received simultaneously,
(vi) the first switch circuit connects the first common terminal to the first selection terminal, and
(vii) the second switch circuit connects the third common terminal to the fourth selection terminal and the fifth selection terminal.

16. The radio frequency circuit according to claim 11,
wherein in a fifth communication mode in which a reception signal in the first band is received,
(viii) the first switch circuit connects the first common terminal to the first selection terminal, and
(ix) the second switch circuit connects the third common terminal to the fourth selection terminal.

17. The radio frequency circuit according to claim 11,
wherein the first switch circuit includes
a first switch connected between the first common terminal and the first selection terminal,
a second switch connected between the second common terminal and the second selection terminal, and
a fifth switch connected between the second common terminal and the third selection terminal,
wherein the second switch circuit includes
a third switch connected between the third common terminal and the fourth selection terminal, and
a fourth switch connected between the third common terminal and the fifth selection terminal, and
wherein a number of stacks of each of the third switch and the fourth switch is smaller than a number of stacks of each of the first switch, the second switch, and the fifth switch.

18. The radio frequency circuit according to claim 11,
wherein the first band is Band 41 for LTE or n41 for 5G NR, and
wherein the second band is Band 1, Band 3, Band 40, Band 25, Band 66, Band 30, Band 7, Band 34, or Band 39 for LTE or n1, n3, n40, n25, n66, n30, n7, n34, or n39 for 5G NR.

19. A communication apparatus comprising:
a signal processing circuit that processes a radio frequency signal; and
the radio frequency circuit according to claim 11 that transmits a radio frequency signal between the signal processing circuit and an antenna.

20. A method of operating a radio frequency circuit, the method comprising:
connecting a first antenna connection terminal to a first selection terminal via a first switch circuit;
connecting the first selection terminal to a first reception filter via a second switch circuit, the first reception filter having a pass band including a first band;
connecting a second antenna connection terminal to a transceiver circuit portion via the first switch circuit, the transceiver circuit portion including a transmission path for the first band and a second reception path for the first band; and
receiving signals in the first band simultaneously via the first reception filter and the second reception path.
